(19) United States
(12) Patent Application Publication
(10) Pub. No.: US 2025/0109454 A1
(43) Pub. Date: Apr. 3, 2025

(54) SYSTEM AND METHOD FOR RECYCLING MAGNETIC MATERIAL AND RARE EARTH ELEMENTS CONTAINED THEREIN

(71) Applicant: CYCLIC MATERIALS INC., Toronto (CA)

(72) Inventors: Ahmad GHAHREMAN, Kingston (CA); Alexander FORSTNER, Peterborough (CA); Matthew James HEPBURN, Toronto (CA); Patrick W. NEE, JR., New York, NY (US)

(21) Appl. No.: 18/979,167

(22) Filed: Dec. 12, 2024

Related U.S. Application Data
(63) Continuation-in-part of application No. PCT/CA2023/050817, filed on Jun. 13, 2023.
(60) Provisional application No. 63/366,374, filed on Jun. 14, 2022.
(60) Provisional application No. 63/399,474, filed on Aug. 19, 2022.
(60) Provisional application No. 63/399,496, filed on Aug. 19, 2022.

(51) Int. Cl. C22B 7/00; C01G 53/84; C22B 1/248; C22B 3/00; C22B 3/44

(52) U.S. Cl. CPC C22B 7/007; C01G 53/84; C22B 1/248; C22B 3/44; C22B 23/0415; C22B 23/0461

(57) ABSTRACT

Methods and systems for the extraction of magnetic material from magnet containing material, and for extraction of rare earth elements (REEs) from the magnetic material are disclosed. An exemplary system includes a milling unit for magnet containing material such as end-of-life motors, hard drives, partially deconstructed motors, magnet-containing end-of-life product, or parts thereof, and outputting magnetic components by exploiting magnetic properties of ferromagnetic and paramagnetic materials in the presence and absence of electromagnetic fields in conjunction with other physical properties such as size and density. The system also includes a chemical processing unit for receiving the magnetic components to extract rare earth elements in the material. Chemical processes are disclosed for separating and recovering rare earth elements, iron, mixed hydroxide precipitate (e.g., nickel, cobalt), and/or boron, from magnetic components.

### CROSS REFERENCES

This application is a continuation-in-part of International Application No. PCT/CA2023/050817, filed Jun. 13, 2023, entitled “System and Method for Recycling Magnetic Material and Rare Earth Elements Contained Therein,” which designated the United States, which PCT application claimed the benefit of U.S. Provisional Application No. 63/366,374 filed 14 Jun. 2022 entitled “System and Method For Recycling Magnetic Material and Rare Earth Elements”; U.S. Provisional Application No. 63/399,474 filed 19 Aug. 2022, entitled “System and Method For Recycling Magnetic Material and Rare Earth Elements”; and U.S. Provisional Application No. 63/399,496 filed 19 Aug. 2022 entitled “System And Method For Physical Separation Of Magnetic Material From Scrap Metal”; the disclosures of each of which are hereby incorporated by reference in their entireties.

### FIELD

The disclosure relates generally to recycling and in particular to systems and methods for recycling magnets and valuable elements contained therein including rare earth elements.

### BACKGROUND OF THE DISCLOSURE

Magnetic material and many elements contained within such materials, including rare earth elements (REEs), play an increasingly critical role in the manufacturing of many of the tools that are necessary to thrive in an advanced economy, ranging from smartphones and high performance magnets to electric vehicles.

The availability of REEs has been constrained by an increased demand, and an insufficient increase in production capacity, resulting in a growing concern that the global economy risks facing a severe shortage of the rare earth elements.

In addition, the increasing importance of climate change has led to the realization that green technologies will become more widely adopted as the only means of achieving sustainability for producing and consuming energy.

Recycling of valuable commodities contained within magnets, such as, but not limited to, rare earth elements thus mitigate each of the aforementioned problems and complements solutions thereto. Recycling is an inherently sustainable method of resource production and clearly reduces demand for new sources of REEs. This in turn eases the constraint on supply chains.

One of the main challenges to recycling rare earth elements is the cost required to purify mixtures obtained from consumer and other discarded devices that contain REEs.

It is thus desirable to improve upon the recovery and recycling of critical rare earth elements to reduce the environmental impact of the global energy transition.

### SUMMARY OF THE DISCLOSURE

In accordance with one aspect of the present invention, there is provided a system for producing a magnet concentrate containing rare earth elements, the system comprising: i) a size reduction unit, for receiving discarded waste containing magnetic material to output mixed scrap, the mixed scrap containing magnetic components and nonmagnetic components; ii) a target magnetic materials extraction block, for receiving and separating the mixed scrap into target magnetic material and non-target material; and iii) a chemical processing unit comprising a) an input for receiving a mixed feed comprising the target magnetic material; b) an acid leaching unit for acid leaching the mixed feed; c) iron removal by pH and/or temperature adjustment and/or by precipitation; d) a rare earth element removal unit for removing rare earth elements from the mixed feed via precipitation as an oxalate, carbonate, or other rare earth salts, or solvent extraction; e) a calcination unit for calcining of the rare earth salts to rare earth oxide; and f) one or more metal recovery units for: 1) removal of one or more of nickel, cobalt, other transition metals by solvent extraction, pH adjustment, and precipitation, and/or ion exchange; 2) removal of copper by precipitation, by pH adjustment, by solvent extraction, or by ion exchange; and/or 3) removal of boron by precipitation, by pH adjustment, by solvent extraction, and/or ion exchange, wherein the target magnetic material include rare earth element(s) containing magnets, such as but not limited to, neodymium magnets, samarium cobalt magnets, and cobalt and/or nickel-comprising magnets such as, but not limited to aluminum nickel cobalt magnets, or any combination thereof.

In accordance with another aspect, there is provided a method for obtaining rare earth elements, the method comprising: (i) milling mixed scrap material containing magnets to a milled material of pre-determined size; (ii) capturing dust generated by said milling in a dust collector; (iii) re-magnetizing the milled material; (iv) vibrating the milled material to promote mixing; (v) passing the milled material over a set of N screens to produce N+1 product fractions, the fractions comprising oversize fraction containing a first set of magnet clumps and fine dust fraction; (vi) combining the fine dust fraction with the dust from the dust collector to form a dust stream; (vii) passing the dust stream through a circuit containing re-magnetizing-clumping-screening to output fine particles comprising a second set of magnet clumps; (viii) short grinding of the magnetic clumps and then screening to capture the magnetic material in the small size fraction of the screen as the mixed feed; (ix) acid leaching the mixed feed; (x) iron removal by pH and temperature adjustment and precipitation; (xi) rare earth element removal by precipitation as an oxalate, carbonate, or other rare earth salts; (xii) calcining of the rare earth salts to rare earth oxide; (xii) (xiii) removal of one or more of nickel and cobalt by solvent extraction, pH adjustment and precipitation as an oxide or hydroxide; (xiv) removal of copper by precipitation or solvent extraction; and/or (xv) removal of boron by solvent extraction or ion exchange.

In accordance with yet another aspect of the present disclosure, there is provided a system comprising (i) a size reduction unit for receiving one or more of any magnet-containing end-of-life products, discarded electric motors (including a subcategory known as ELMO), hard disk drives, and meatballs (partially-deconstructed or shredded electric motors, also known as SHELMO) to output mixed scrap having magnetic and non-magnetic components; and (ii) a target magnetic materials extraction block for receiving the magnetic components and separating the magnetic components into target magnetic material and non-target material; wherein the target magnetic materials are an end product to be processed separately.

In accordance with yet another aspect of the present disclosure, there is provided a method of preparing a magnet concentrate. The method includes: obtaining feed material containing magnetic material, the magnetic material comprising ferromagnetic material and non-ferromagnetic material; reducing the size of the feed material; separating the reduced size feed material into the ferromagnetic material and the non-ferromagnetic material; and separating the ferromagnetic material into a target magnetic material concentrate (also referred to as “magnet concentrate”) and a non-target magnetic material depleted scrap.

In accordance with yet another aspect, there is provided a method of preparing a magnet concentrate. The method includes one or more of: milling mixed scrap material containing magnets to a milled material of pre-determined size; capturing dust generated by milling in a dust collector; re-magnetizing the milled material; vibrating the milled material to promote mixing; passing the milled material over a set of N screens to produce N+1 product fractions, the fractions comprising oversize fraction containing a first set of magnet clumps and fine dust fraction; combining the fine dust fraction with the dust from the dust collector to form a dust stream; passing the dust stream through a circuit containing re-magnetizing-clumping-screening to output fine particles comprising a second set of magnet clumps; rapid grinding the magnet clumps and screening, collecting the smallest size fraction as the target magnetic material concentrate; and combining the fine particles to form the magnet concentrate.

In accordance with another aspect of the present disclosure, there is provided a system for obtaining rare earth elements comprising: (i) a milling/washing block for receiving swarf and discarded magnet material and outputting magnetic components; and (ii) a chemical processing unit for receiving magnetic components from one or more of a target magnetic materials extraction block and the milling/washing unit to extract rare earth elements in the material.

In another aspect, there is provided a process for obtaining rare earth elements from a mixed feed, the process comprising: acid leaching the mixed feed; iron removal by pH adjustment and precipitation; rare earth element removal by precipitation as an oxalate, carbonate, or other rare earth salts; calcining of the rare earth salt to rare earth oxide; removal of one or more of nickel, cobalt, other transition metals by solvent extraction, pH adjustment, and precipitation as a hydroxide; removal of copper by precipitation, by solvent extraction, or by ion exchange; and removal of boron by solvent extraction, ion exchange, or precipitation.

Other technical advantages may become readily apparent to one of ordinary skill in the art after review of the following figures and description.

### BRIEF DESCRIPTIONS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 shows a simplified block diagram of a system for use in recycling materials including rare earth elements, from discarded motors, hard disk drives, and other waste in accordance with an embodiment;

FIG. 2 is a schematic diagram showing various physical components of an embodiment of a system for separating magnetic and nonmagnetic components;

FIG. 3 is a schematic diagram showing various physical components of another embodiment of a system for separating magnetic and nonmagnetic components;

FIG. 4 is a schematic diagram showing various physical components of another embodiment of a system for separating magnetic and nonmagnetic components;

FIG. 5 is a schematic diagram showing various physical components of another embodiment of a system for separating magnetic and nonmagnetic components having a belt-mounted magnetizer/demagnetizer;

FIG. 6 is a schematic block diagram of a process for producing a magnet concentrate by screening out clumps of magnet material in accordance with an embodiment and includes pictures of processed material with the magnetic clumps on the far left and progressively smaller size fractions to the right;

FIG. 7 is a flowchart of a specific process in accordance with one embodiment of the process of FIG. 6;

FIG. 8 is a schematic diagram showing various physical components of another embodiment of a system for separating magnetic and nonmagnetic components having a magnetic detector and a computing device for signal processing;

FIG. 9 is a block diagram of various physical elements of computer device of FIG. 8;

FIG. 10 illustrates schematic block diagrams illustrating variations of embodiments involving selective calcination of a mixed oxalate;

FIG. 11 is a flowchart of a process combination used to output an enriched magnet concentrate from mixed scrap material;

FIG. 12 is a schematic illustration of an embodiment of a cleaning process of swarf;

FIG. 13 is a flowchart of chemical processing steps used to convert a variety of magnet-containing feeds into a rare earth concentrate in one embodiment;

FIG. 14 is a flowchart of another embodiment of the process of FIG. 13, comprising additional steps;

FIGS. 15-17 depicted flow diagrams associated with the system of FIG. 1;

FIG. 18 is a flowchart of chemical processing steps used to convert a variety of magnet-containing feeds into a rare earth concentrate in one embodiment;

FIGS. 19-21 are charts depicting results of Examples 1 through 5 related to embodiments of the present disclosure; and

FIG. 22 depicts the results of an ¹¹B NMR performed on a resulting solid produced from boron removal techniques related to embodiments of the present disclosure.

Unless otherwise specifically noted, articles depicted in the drawings are not necessarily drawn to scale.

### DETAILED DESCRIPTION

The presented technology processes a variety of end-of-life devices to capture value from the content of the contained commodities. Such devices include, but are not limited to, electric motors, hard drives, speakers, compressors, electromagnetic imaging devices (e.g., magnetic resonance imaging (MRI) machine), meatball (partially deconstructed motors), other electromagnetic devices containing magnets, and any magnet-containing end-of-life products or any parts thereof.

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

As used herein, “rare earth elements (REEs)” refers to lanthanides and scandium and yttrium. Specifically, REEs include lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), Erbium (Er), Thulium (Tm), ytterbium (Yb), lutetium (Lu), scandium (Sc), and yttrium (Y). REEs may otherwise be referred to as “rare earth metals”, “rare earths,” and the like.

As used herein, a “magnet” refers to an object made from magnetic materials and is capable of producing a magnetic field. A magnet may refer to an object currently producing a magnetic field or an object capable of being magnetized, such as demagnetized magnets. A magnet of the present disclosure may include permanent magnets, temporary magnets, electromagnets, or combinations thereof. Permanent magnets are typically naturally-occurring elements or chemical compounds that do not easily lose their magnetism. Non-limiting examples of permanent magnets include neodymium Iron Boron (NdFeB), samarium Cobalt (SmCo), aluminum-, cobalt- and nickel-comprising magnets (AlNiCo), and iron oxide- and/or barium-comprising magnets (e.g., ceramic, ferrite). Temporary magnets become magnetized when contacted with a magnetic field, but may lose their magnetism gradually as the field is removed. Electromagnetic magnets require an electric current to produce a magnetic field. “Magnets” of the present disclosure may include rare earth magnets and non-rare earth magnets.

The term “rare earth magnet” is a permanent magnet comprising one or more rare earth elements, typically in the form of alloys. The two primary types of rare earth magnets comprise neodymium magnets and samarium-cobalt magnets. A neodymium magnet (also known as NdFeB, NIB or Neo magnet) is a permanent magnet made from an alloy of neodymium, iron, and boron to form the Nd₂Fe₁₄B tetragonal crystalline structure and also comprising one or more of other REEs such as Pr, Dy, Tb etc. A samarium-cobalt (SmCo) magnet is a permanent magnet made of two basic elements, namely samarium and cobalt and may comprise other REEs in small fraction. In embodiments, the rare earth compound(s) of the rare earth magnets of the present disclosure are substantially (e.g., at least about 50 wt. %, at least about 75 wt. %, at least about 90 wt. %, at least about 99 wt. %) composed of neodymium, samarium, terbium, dysprosium, praseodymium, and combinations thereof. In embodiments, the rare compound(s) of the rare earth magnets of the present disclosure comprise less about 10 wt. %, or more particularly less than about 5 wt. %, or more particularly less than about 2 wt. %, or more typically less than about 1 wt. % of lanthanum and cerium. Typically, a rare earth magnet comprises at least about 20 wt. % rare earth compounds, more typically at least about 25 wt. %, and even more typically at least about 30 wt. % rare earth compounds.

“Non-rare earth magnets” may refer to any magnet that does not include rare earth elements including but not limited to aluminum-, cobalt- and nickel-comprising magnets (AlNiCo), and iron oxide- and/or barium-comprising magnets (e.g., ceramic, ferrite). Stated differently, non-rare earth magnets typically are substantially free of rare earth compounds and more typically comprise no more than about 0.1 wt. % rare earth compounds, and more typically no more than about 0.05 wt. % rare earth compounds.

As used herein, “magnetic material”, “magnetic component” or the like refers to materials capable of being affected by external electromagnetic fields in their surroundings. Magnetic materials of the present disclosure may include magnets, de-magnetized magnets, or magnetic metals not themselves capable of producing a magnetic field. Magnetic metals may include elemental metals such as iron, cobalt, nickel, boron, barium, gadolinium, dysprosium, neodymium, samarium, etc. and magnetic compounds such as steel, stainless steel, and other ferromagnetic iron alloys, ferrite, Alnico, Permalloy, etc. Magnetic materials used herein may include ferromagnetic metals, paramagnetic materials, diamagnetic materials, or combinations thereof.

As used herein, “non-magnetic material,” “non-magnetic compounds,” or the like refers to materials that do not and will not produce a magnetic field and are not affected by magnetic fields. Non-limiting examples of non-magnetic materials include non-magnetic metals such as aluminum, copper, and gold, and other materials such as water, plastic, wood, rubber, etc.

“Ferromagnetic” refers to metals that can be magnetized. In their natural state, these metals are usually not magnetic themselves but will be attracted to objects which produce magnetic fields. When they are magnetized, they become magnets themselves. Non-limiting examples of ferromagnetic materials include cobalt, iron, ferric oxide, nickel, gadolinium, dysprosium, terbium, manganese, neodymium, and chromium dioxide.

As used herein, “non-ferromagnetic” refers to materials that have little or no attraction to magnetic fields, such as wood, rubber, plastics, aluminum, copper, brass, gold, silver, titanium, tungsten, zinc, and lead.

A “mixed feed” or the like, as used herein, refers to a feed of materials comprising magnetic or potentially magnetic materials, such as REE-comprising materials or magnets, non-REE materials or magnets, or a combination thereof. The magnetic materials in a mixed feed of the present disclosure may be operative, defective, whole, in pieces, demagnetized, or the like. The magnets may be free or unbound or may be contained within a larger part, such as discarded motors, discarded wind turbines, discarded magnetic resonance imaging machines, hard disk drives, meatballs, swarf, and other electromechanical waste. A mixed feed of the present disclosure may include materials that are or were recycled, scrap, trashed, discarded, reclaimed, recovered, salvaged, or the like.

“Target magnetic materials,” as used herein, refers to rare earth element(s) comprising magnets, such as but not limited to, neodymium magnets, samarium cobalt magnets, cobalt and/or nickel-comprising magnets such as, but not limited to aluminum nickel cobalt magnets, or any combination thereof.

“Non-target materials,” used herein, refers to non-magnetic materials (e.g., plastic, aluminum, copper, zinc) and non-target magnetic materials (e.g., steel and other ferromagnetic iron alloys).

“Swarf”, as used herein, refers to pieces of metal that are debris or waste resulting from machining, or similar subtractive manufacturing processes and includes anything and everything related to magnet manufacturing and/or production waste or by-product that contains rare earth. Swarf can be small particles; long, stringy tendrils; slag-like waste; or dust.

As used herein, “clumps,” “clumped material,” and the like refers to an aggregate composition (e.g., agglomerate, collection) of materials where the predominant force holding the materials together in the clump is magnetic attraction. The magnetic force causing the attraction results from the magnetic field applied by paramagnetic materials, ferromagnets, ferrimagnets, superparamagnetic materials, and other magnets in the clump. A “clump” of the present disclosure is predominantly composed of materials having magnetic properties, including magnetic and ferrous material (e.g., steel and ferromagnetic iron alloys), and in some embodiments, trace amounts (i.e., less than about 10 wt. %, less than about 5 wt. %, less than about 1 wt. %) of copper and aluminum.

“Size reduction apparatus,” “size reduction device,” “comminuting apparatus,” “comminuting apparatus,” and the like referred to herein may be used interchangeably and are used herein to describe ball mills, hammer mills, rod mills, other known apparatuses used for size reduction techniques, and combinations thereof.

“Electrochemical devices,” refers to device that generates electrical energy from chemical reactions and may include, but is not limited to, torches and flashlights, electrical appliances such as cellphones (long-life alkaline batteries), digital cameras (lithium batteries) hearing aids (silver-oxide batteries), digital watches (mercury/silver-oxide batteries), military devices (thermal batteries), wind turbines, and power generators, and may otherwise be referred to as “electrochemical machinery,” “electrochemical equipment,” and the like.

As used herein, “tenacious” with reference to feed material may be refer to hard, or heavy materials, as compared to “tender” materials. Tenacious materials may include motors.

As used herein, “tender” with reference to feed material may be refer to soft materials as compared to “tenacious” materials. Tender materials may include HDDs.

“Substantially free” as used herein, generally refers to compositions of less than about 25 wt. %, or more typically less than about 20 wt. %, or more typically less than about 15 wt. %, or more typically less than about 10 wt. %, or more typically less than about 5 wt. %, or more typically less than about 1 wt. %.

### System Overview

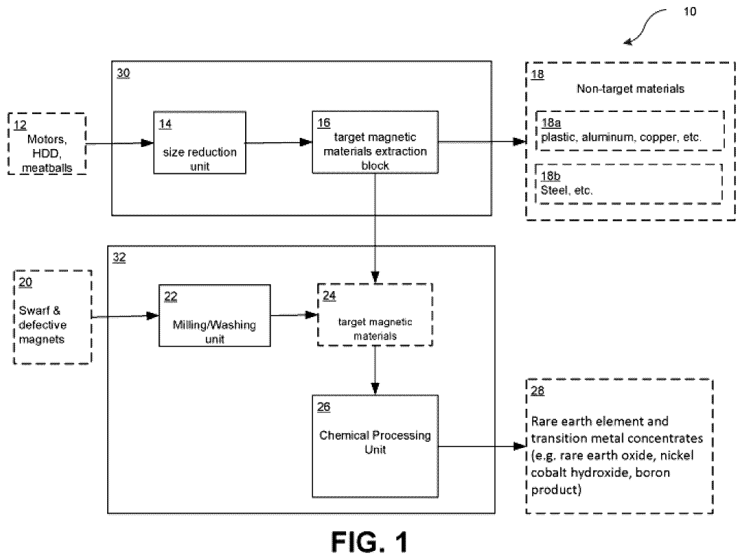

A simplified block diagram of system 10 for use in recycling materials including magnets and rare earth elements, from discarded motors, hard disk drives, and other electromechanical waste in accordance with an embodiment is depicted in FIG. 1.

As shown, system 10 includes a first subsystem 30 for receiving discarded waste 12 (e.g., motors, hard disk drives (HDDs), meatballs) and separating them into magnetic and non-magnetic components, and a second subsystem 32 for receiving a magnet concentrate from subsystem 30 as well as swarf and defective magnets and for obtaining a rare earth element concentrate.

Subsystem 30 includes a size reduction block 14 and a target magnetic materials extraction block 16. Size reduction block 14 receives waste 12 including discarded electric motors (e.g., a subcategory known as ELMO), hard disk drives, meatballs (i.e., partially deconstructed or shredded electric motors, also known as SHELMO), other magnet-comprising electronic components, or combinations thereof. Components of waste 12 may include rare earth element-comprising magnets, such as but not limited to, neodymium magnets, samarium cobalt magnets, cobalt and/or nickel-comprising magnets such as, but not limited to aluminum nickel cobalt magnets, or any combination thereof. Rare earth element-comprising magnets typically include one or more of iron, nickel, cobalt, neodymium, boron, aluminum, niobium, dysprosium, samarium, praseodymium, terbium, copper, barium, hafnium, zirconium, and manganese. In a non-limiting example, neodymium magnets are primarily made with an alloy of neodymium (about 29 to about 32 wt. %), iron (about 65 to about 69 wt. %), and boron (about 1 wt. %) and may also have small amounts (i.e., less than about 5 wt. % total) of elements including praseodymium, dysprosium, terbium, and cobalt. In another non-limiting example, samarium cobalt magnets are primarily made with an alloy comprising samarium (about 35 wt. %) and cobalt (about 60 wt. %) and may also include small amounts (i.e., less than about 5 wt. %) of iron, copper, hafnium, zirconium, and praseodymium. Waste 12 may also include other ferromagnetic material such as steel and other ferromagnetic iron alloys and non-ferromagnetic materials such as plastics, glass, aluminum and copper.

The size reduction block 14 may receive the waste 12 in any size but typically ranging from about 0.5 to about 36 inches. Size reduction block 14 reduces the received waste 12 in size, in a controlled manner that is suitable for further processing, such that magnets are mostly preserved. In a non-limiting example, the size reduction block 14 comprises a mill, such as a hammer mill designed to grind, mill, and/or crush the received waste 12 to achieve the reduced size in a controlled manner. The size reduction block 14 reduces the size of at least most (i.e., at least about 75%, at least about 80%, at least about 85%, at least about 90%, at least about 95%, at least about 99% by mass) of the waste 12. Traditional crushing, smashing or pulverization of materials containing magnets in an uncontrolled environment may lead to loss of magnets, which may stick to surrounding objects or surfaces exhibiting ferromagnetic properties.

At target magnetic materials extraction block 16, target magnetic materials 24 are separated or extracted from the reduced material at the output of block 14, as described in further detail below. Target magnet materials 24 include rare earth element(s) comprising magnets.

The target magnetic materials extraction block 16 may separately extract non-target materials 18 and target magnetic materials 24. Non-target materials 18 include non-magnetic materials 18a (such as plastic, aluminum, copper) and non-target magnetic materials 18b such as steel and other ferromagnetic iron alloys.

In embodiments, at least about 75%, or more typically at least about 80%, or more typically at least about 85%, or more typically at least about 90%, or more typically at least about 95%, or more typically at least about 99%, or more typically at least about 99.5% by mass of the magnets from waste 12 are recovered in the target magnetic material 24.

In embodiments, the target magnetic materials 24 from subsystem 30 may be substantially free of non-target materials 18. That is, the target magnetic materials 24 from subsystem 30 may comprise less than about 25 wt. %, or more typically less than about 20 wt. %, or more typically less than about 15 wt. %, or more typically less than about 10 wt. %, or more typically less than about 5 wt. %, or more typically less than about 1 wt. % of non-target materials 18.

The non-target materials 18 may be substantially depleted of rare-earth comprising magnets and/or elements. In embodiments, the non-target materials 18 may comprise less than about 20 wt. %, or more typically less than about 15 wt. %, or more typically less than about 10 wt. %, or more typically less than about 5 wt. %, or even more typically less than about 1 wt. %, rare-earth comprising magnets and/or elements.

In embodiments, the non-target magnetic materials 18b is separated from and is substantially free of non-magnetic materials 18a, i.e., comprising less than about 10 wt. %, or more typically less than about 5 wt. %, or more typically less than about 3 wt. %, or even more typically less than about 1 wt. % non-magnetic materials 18a. In embodiments, the non-magnetic materials 18a and non-target magnetic materials 18b are combined in non-target materials 18. Non-target materials 18 may include forms of steel and other ferromagnetic iron alloys, copper, aluminum, and plastics and non-metallics.

System 10 also includes a second subsystem 32, that is an example of an embodiment of the present disclosure, for receiving discarded waste and/or by-products 20 in the form of swarf, defective and/or magnets that are not usable in their current state. Discarded waste 20 is substantially free (i.e., comprising less than about 50 wt. %, less than about 25 wt. %, less than about 15 wt. %, less than about 10 wt. %, or less than about 5 wt. %, or less about 1 wt. %) of non-target materials including non-magnetic materials 18a (such as but not limited to plastic, aluminum, copper) and non-target magnetic materials 18b such as steel and other ferromagnetic iron alloys. Discarded waste 20 may be input to milling/washing block 22.

A milling/washing block 22 receives the swarf, defective magnets, and/or currently unusable magnets, and outputs target magnetic material 24. In embodiments, milling/washing block 22 occurs in subsystem 30 and/or subsystem 32. If milling/washing block 22 is included in subsystem 30, the milling/washing block 22 may be included prior to or after size reduction unit 14. Additionally or alternatively, the milling/washing block 22 may occur prior to or after target magnetic materials extractions block 16. Additionally or alternatively, a milling/washing block 22 in subsystem 30 may occur in parallel to the size reduction unit 14 and/or target magnetic materials extraction block 16, and the milled and/or washed material from the milling/washing block 22 may be combined with the output of block 16 to produce target magnetic materials 24. If milling/washing block 22 is included in subsystem 32, the milling/washing block 22 may be configured to receive swarf, defective magnets and/or currently unusable magnets from block 20 and output target magnetic materials 24.

Target magnetic materials 24 may include diamagnetic, ferromagnetic, and paramagnetic metal-comprising components. As used in this document, target magnetic material includes rare earth element(s) containing magnets, such as but not limited to neodymium magnets, samarium cobalt magnets, cobalt and/or nickel containing magnets such as, but not limited to aluminum nickel cobalt magnets, or any combination thereof. In embodiments, swarf may not require milling and may bypass milling/washing block 22 and be presented directly as forming part of target magnetic materials 24. Defective magnets and large magnets may or may not require demagnetizing before being provided to milling/washing block 22.

Target magnetic materials 24 may therefore result from one or both target magnetic materials extraction block 16 of subsystem 30 and milling/washing block 22 of subsystem 32. As depicted in FIG. 1, some or all of the target magnetic materials 24 may also be obtained directly from swarf and unusable magnets in discarded waste 20 without necessarily going through the milling block 22. In embodiments, the target magnetic materials 24 from subsystem 30 and/or subsystems 32 may be substantially free of non-target materials (e.g., plastic, aluminum, copper, steel and other ferromagnetic iron alloys). That is, the target magnetic materials 24 from subsystem 30 may comprise less than about 60 wt. %, or more typically less than about 25 wt. %, or more typically less than about 15 wt. % or more typically less than about 10 wt. %, or more typically less than about 5 wt. %, or more typically less than about 1 wt. % of non-target materials.

In embodiments, the target magnetic materials 24 from subsystem 30 and/or subsystems 32 may be substantially uniform in size.

The target magnetic materials 24 are further processed in a chemical processing block 26, as described in more detail below, to obtain one or more rare earth element and transition metal concentrates 28. Chemical processing block 26 may include sub-blocks for hydrometallurgical and non-hydrometallurgical steps. The one or more concentrates 28 may include, for example, a rare earth element concentrate, cobalt and/or a nickel concentrate, and a boron concentrate in elemental form and/or as compounds (e.g., rare earth oxides, nickel cobalt hydroxide).

Conventional operations process these end-of-life devices (e.g., electric motors, HDDs, and/or meatball) and separate their components into base metals, typically, copper, aluminum, and steel and other ferromagnetic iron alloys. Conventionally, valuable magnet material may travel through a process with steel and other ferromagnetic iron alloys and is finally deposited with the steel and other ferromagnetic alloys. Embodiments of the present disclosure, such as that depicted in FIG. 1, however, achieve the separation of the valuable magnet material from steel and other ferromagnetic alloys.

Several embodiments of systems and/or methods for separating valuable magnet materials are described in the present disclosure, with reference to several specific embodiments, as disclosed below.

Preliminary research has demonstrated that various applications of the described embodiments has upgraded the concentration of magnets in magnet-comprising material from approximately less than 6% magnets by mass to about 30% magnets by mass or higher. Refinement of the technique may achieve magnet upgrading to about 100% by mass.

### Embodiment 1—Separation of Magnets from Steel and Other Ferromagnetic Iron Alloys and Non-Ferromagnetic Material Using a Ferromagnetic Gathering Surface

According to a first set of embodiments, there are provided systems and methods of separating magnets from steel using a ferromagnetic gathering surface. It is well known that magnetized material is attracted to ferromagnetic iron alloys. In one embodiment, this property is exploited to selectively sort magnets from mixed scrap material including from ferrous material (e.g., steel and other ferromagnetic iron alloys).

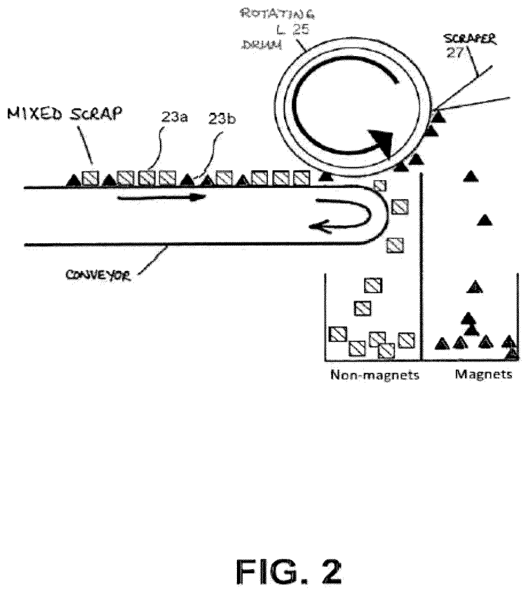

In one embodiment, illustrated in FIG. 2, milling is used to form small discrete components of consistent size of a mixed scrap 23 which include non-magnetized components 23a and magnetized components 23b. Non-magnetized components 23a may refer to non-target materials 18 as described with reference to FIG. 1 and may include plastic, rubber, glass, non-magnetic metals such as aluminum and copper, steel, and other ferromagnetic iron alloys etc., or combinations thereof. Magnetized components 23b may refer to target magnetic materials 24 as described with reference to FIG. 1 and may comprise rare earth element(s)-comprising magnets, such as but not limited to neodymium magnets, samarium cobalt magnets, cobalt and/or nickel-comprising magnets such as, but not limited to aluminum nickel cobalt magnets, or any combination thereof. The mixed scrap 23 may comprise any ratio of non-magnetized components 23a to magnetized components 23b.

The components of mixed scrap 23 are conveyed along a non-ferromagnetic conveyor belt such as a rubber belt, which passes underneath, and may be in physical contact with, a rotating or revolving steel or other ferromagnetic iron alloy drum 25. The conveyor belt may move at a substantially consistent speed. The steel or other ferromagnetic iron alloy drum may move at a substantially consistent speed. In embodiments, the steel or other ferromagnetic iron alloy drum may rotate at a same or similar speed to the conveyor belt. In embodiments, the steel or other ferromagnetic iron alloy drum may rotate at different speed to the conveyor belt. The steel or other ferromagnetic iron alloy drum may rotate in the opposite direction to the conveyor belt. In the example depicted in FIG. 2, the conveyor belt rotates clockwise and the steel or other ferromagnetic iron alloy drum rotates counter clockwise to carry the magnetized components away from the conveyor belt and non-magnetized components 23a. The magnetized components stick to the drum and are scraped off for collection by a scraper 27. The scraper 27 may be substantially fixed or immobile.

The non-magnetized components 23a may be discharged from the conveyor belt into a first storage unit (e.g., containers, bins) and the magnetized components 23b (which are magnetically attracted to and in contact with the steel or other ferromagnetic iron alloy drum) may be scraped from the steel or other ferromagnetic iron alloy drum 25 into a second storage unit. The first storage unit may be substantially free of magnetized components 23b. That is, the composition of components in the first storage unit comprises less than about 10%, or more typically less than about 5%, or even more typically less than about 1% by mass of magnetized components 23b.

The embodiment depicted in FIG. 2 is highly efficient such that the second unit captures substantially all the magnetized components 23b that enter onto the conveyor. That is, less than about 25%, or more typically less than about 10%, or even more typically less than about 5% by mass of the magnetized components 23b that are placed onto the conveyor are discharged into the first unit or are otherwise lost (i.e., not discharged in the second unit). The composition of components in the second unit is substantially free of non-magnetized components 23a. That is, non-magnetized components 23a comprises less than about 50%, or more typically less than about 40%, or more typically less than about 30%, or more typically less than about 20%, or more typically less than about 10%, or more typically less than about 5% by mass of the total component composition stored in the second unit. Stated differently, the magnetized components 23b comprise at least about 50%, or more typically at least about 90%, or even more typically at least about 95% by mass of the total component composition stored in the second unit.

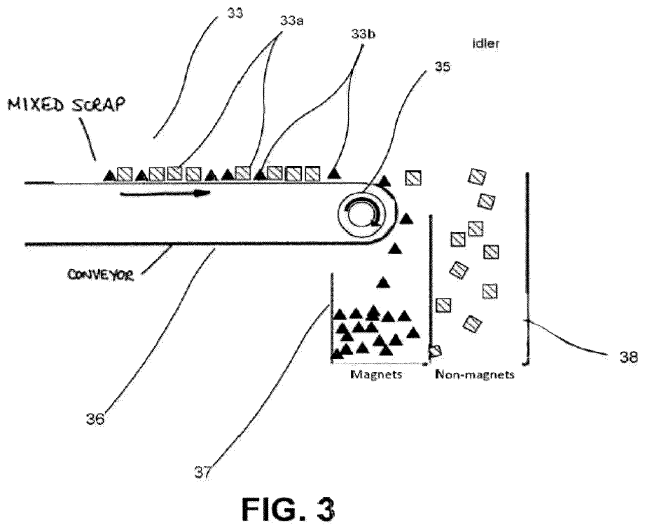

Elements of FIG. 2, including but not limited to the speed of the belt, the speed of the drum 25, the position of the scraper 27 relative to the drum and/or relative to the storage units, the size of the mixed scrap 23, the size of the storage units, the placement or distance of the storage units from the conveyor and/or scrapper 27, the distance between storage units, the width of the conveyor belt, the width of the drum 25, etc. are designed to achieve a high efficiency separation of magnetized components 23b from the scrap 23, and/or a high degree of capture of the magnetized components 23b into the second storage unit. In embodiments, the elements of FIG. 2 are designed so as to separate at least most (i.e., at least about 50%, at least about 75%, at least about 85%, at least about 90%, at least about 95%, at least about 99% by mass) of the magnetized components 23b from the non-magnetized components 23a for discharge into separate storage units. In another embodiment, illustrated in FIG. 3, a mixed scrap 33 containing non-magnetized components 33a and magnetized components 33b is conveyed on a variable speed thin non-ferromagnetic belt (e.g., rubber belt) conveyor 36.

At the end of the conveyor 36 the belt passes over a steel or other ferromagnetic iron alloy idler 35 that exerts passive attraction on any magnetized components 33b within the mixed scrap 33. As a result of the magnetic force of attraction, magnetized components 33b are thrown a shorter distance off the belt, whereas non-magnetized material is thrown further, allowing the discrete components of the material to be sorted into magnetized and non-magnetized components within two bins 37, 38 respectively.

The relative magnitude of this effect can be controlled by varying the speed of the belt, the thickness of the belt, the size of the mixed scrap 33, or combination thereof. The belt conveyor 36 and idler 35 may operate at substantially the same speeds. In embodiments, the speed and thickness of the belt conveyor 36 and/or idler 35 may be based on the magnetic force to be applied to the magnetized components 33b, the magnetic force of the idler 35, or both. In embodiments, the magnetized components 33b typically travel a horizontal distance on the conveyor 36 to bin 37. In embodiments, the non-magnetized components 33a typically travel a horizontal distance from the conveyor 36 to bin 38.

Elements of FIG. 3, including but not limited to the speed of the belt, the thickness of the belt, the size of the mixed scrap 33, the size of the bins 37 and 38, the placement or distance of the bins 37 and 38 from the conveyor 36, the distance between bins 37 and 38, the width of the conveyor 36, the width of the idler 35, etc. are designed to achieve a high efficiency separation of magnetized components 33b from the scrap 33, and/or a high degree of capture of the magnetized components 33b into bin 37. In embodiments, the elements of FIG. 3 are designed so as to separate at least most (i.e., at least about 50%, at least about 75%, at least about 85%, at least about 90%, at least about 95%, at least about 99% by mass) of the magnetized components 33b from the non-magnetized components 33a for discharge into separate bins.

In an example, elements of FIG. 3 are designed so that the horizontal distances traveled by the non-magnetized components 33a and the magnetized components 33b do not overlap or separated by a sufficient difference. In a specific non-limiting example, the process of FIG. 3 may be configured so the non-magnetized components 33a travel from about 2 inches to 5 feet from the conveyor 36 and the magnetized components 33b travel from about 0.5 inches to about 2 feet from the conveyor 36.

The embodiment depicted in FIG. 3 is highly efficient such that the magnet bin 37 captures substantially all the magnetized components 33b that enter onto the conveyor 36. That is, less than about 25%, or more typically less than about 15%, or even more typically less than about 5% by mass of the magnetized components 33b that are placed onto the conveyor 36 are discharged into bin 38 or are otherwise lost (i.e., are not discharged into bin 37). The composition of components in bin 37 is substantially free of non-magnetized components 33a. That is, non-magnetized components 33a comprises less than about 50%, or more typically less than about 25% or more typically less than about 10% by mass of the total component composition stored in bin 37. Stated differently, the magnetized components 33b comprise at least about 50%, or more typically at least about 75%, or even more typically at least about 90% by mass of the total component composition stored in bin 37.

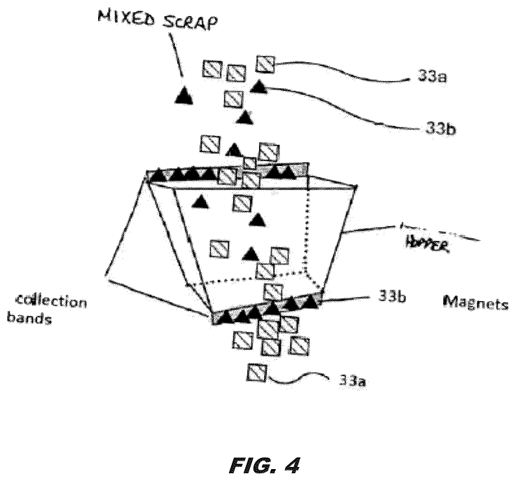

The non-magnet bin 38 may be substantially free of magnetized components 33b. That is, the composition of components in the non-magnet bin 38 comprises less than about 10%, or more typically less than about 5%, or even more typically less than about 1% by mass of magnetized components 33b. In another embodiment depicted in FIG. 4, mixed scrap 33 (such as that described with reference to FIG. 3) is configured to slide down a gently sloped vibrating steel or other ferromagnetic iron alloy plate of an otherwise non-ferromagnetic hopper (e.g., non-steel or other ferromagnetic iron alloy hopper). Magnetized components 33b are attracted to the steel or other ferromagnetic iron alloy plate and therefore slide more slowly than non-magnetized components 33a. The discrete components of the material partitions into two cuts, one enriched in magnets.

The slope of the steel or other ferromagnetic iron alloy plate may range from about 30° to about 85°, or more typically from about 45° to about 80°, or more typically from about 50° to about 75°, or more typically from about 55° to about 70°, relative to a horizontal surface.

The non-magnetized components 33a may be discharged from the steel or other ferromagnetic iron alloy plate into a first storage unit (e.g., containers, bins) and the magnetized components 33b may be scraped or removed from the steel or other ferromagnetic iron alloy collection bands by any means to form a magnetized component concentrate. The first storage unit may be substantially free of magnetized components 33b. That is, the composition of components in the first storage unit comprises less than about 10%, or more typically less than about 5%, or even more typically less than about 1% by mass of magnetized components 33b.

The magnetized component concentrate may capture substantially all the magnetized components 33b that enter into the hopper. That is, less than about 10%, or more typically less than about 5%, or even more typically less than about 1% by mass of the magnetized components 33b that are placed onto the hopper are discharged into the first unit or are otherwise lost. The composition of the magnetized component concentrate is substantially free of non-magnetized components 33a. That is, non-magnetized components 33a comprises less than about 50%, or more typically less than about 25% or more typically less than about 10% by mass of the total magnetized component concentrate composition. Stated differently, the magnetized components 33b comprise at least about 50%, or more typically at least about 75%, or even more typically at least about 90% by mass of the total magnetized component concentrate composition.

Elements of FIG. 4, including but not limited to the slope of the plate, the vibration of the plate, the size or configuration of the hopper, the material of the hopper, the method of removing the magnetized components 33b from the hopper, the size of the mixed scrap 33, etc. are designed to achieve a high efficiency separation of magnetized components 33b from the scrap 33, and/or a high degree of capture of the magnetized components 33b. In embodiments, the elements of FIG. 4 are designed so as to separate at least most (i.e., at least about 75%, at least about 80%, at least about 85%, at least about 90%, at least about 95%, at least about 99% by mass) of the magnetized components 33b from the non-magnetized components 33a.

Non-magnetized components 33a of FIGS. 3 and 4 may refer to non-target materials 18 as described with reference to FIG. 1 and may include plastic, rubber, glass, non-magnetic metals such as aluminum and copper, steel and other ferromagnetic iron alloys, etc., or combinations thereof. Magnetized components 33b may refer to target magnetic materials 24 as described with reference to FIG. 1 and may comprise rare earth element(s)-comprising magnets, such as but not limited to neodymium magnets, samarium cobalt magnets, cobalt and/or nickel-comprising magnets such as, but not limited to aluminum nickel cobalt magnets, or any combination thereof.

The mixed scrap 33 may comprise any ratio of non-magnetized components 33a to magnetized components 33b.

A ferromagnetic “collection band” is then added as a collection point for lightweight magnetic particles, such as particles less than about 500 grams, or more typically less than about 400 grams, or more typically less than about 300 grams, or more typically less than about 200 grams, or more typically less than about 100 grams. The magnetic particles are harvested. In embodiments, the magnetic particles are harvested with a scraper, though the magnetic particles may be removed from the band by any means. The magnetic particles may be removed from the band periodically (i.e., at recurring in time intervals), or as needed (i.e., the collection band is substantially at capacity by weight, surface area, etc.).

The above embodiments may be enhanced by ensuring that there are no competing ferromagnetic surfaces for the magnetic components from the mixed scrap to adhere to. This may involve, for example, replacing steel and other ferromagnetic iron alloy conveyor belt rollers with nylon rollers, replacing steel and other ferromagnetic iron alloy chutes with fiberglass chutes, and replacing carbon steel mechanical parts with stainless steel parts. Adjacent equipment such as mills, conveyors, chutes and storages may be modified or redesigned accordingly.

In some embodiments, fragmented magnets may be too weakly magnetic to be sufficiently attracted to a steel surface or plate, even if the fragmented magnets come into direct contact. Moreover, a significant amount of bulk ferrous material may follow the magnets. In such cases, the embodiments may be used for partial upgrading step of the scrap mix, which will further be processed.

### Embodiment 2—Use of Demagnetization and Re-Magnetization to Separate Magnets from Steel and Other Ferromagnetic Iron Alloys and Non-Ferromagnetic Materials

As noted above, magnetized material is attracted to ferromagnetic iron alloys such as steel. Accordingly, in a conventional scrap processing line, the magnetic components follow the steel and other ferromagnetic iron alloys through the process. In sharp contrast to conventional scrap processing, in one embodiment, the magnetic components are demagnetized, and subsequently separated from steel and other ferromagnetic iron alloys by exploiting their other properties, such as size and/or density, or differences in hardness.

A magnet can be demagnetized to reduce or remove substantially magnetic properties from the magnet, such as the magnetic field strength (H). According to embodiments herein, a magnet can be partially, mostly, or substantially completely demagnetized thermally, physically, electromagnetically, and/or over time. In embodiments, the magnets are demagnetized as a bi-product to processing disclosed herein such as milling. In embodiments, separation procedures disclosed herein may include a demagnetization step.

A demagnetization method may include heating a magnet to a high temperature, such as the Curie temperature of the magnet, for a period of time. A magnet will lose at least part of and typically most of its magnetic field strength and may become partially, mostly, or substantially completely demagnetized permanently if exposed to a temperature near or above its maximum operating temperature for a period, or if heated above its Curie temperature (i.e., the temperature at which all magnetization of the magnet is permanently lost). In between the maximum operating temperature and the curie temperature, some percentage of the magnetization is irreversibly lost. By way of example, neodymium-comprising magnets (e.g., NdFeB magnets) typically have a maximum operating temperature of about 150° C. and have a Curie temperature ranging from about 310-400° C. Samarium cobalt magnets can typically withstand operating temperatures of up to about 310° C., and have a Curie temperature ranging from about 700-800° C. Alnico magnets can typically operate at temperatures up to about 525° C. and have a Curie temperature of about 800° C. Ferrite (ceramic) magnets typically have a maximum operating temperature of about 250° C. and a Curie temperature of around 450° C.

Other example demagnetization methods include dropping the magnet frequently, apply a hammering action or other force to the magnet repeatedly, bringing the magnet in contact with the like poles of other magnets repeatedly, passing an electric current through the magnet, leaving the poles of the magnets bare for a long duration (i.e., self-demagnetization), exposure to an oscillating diminishing magnetic field, etc. Multiple demagnetization techniques may be applied in combination.

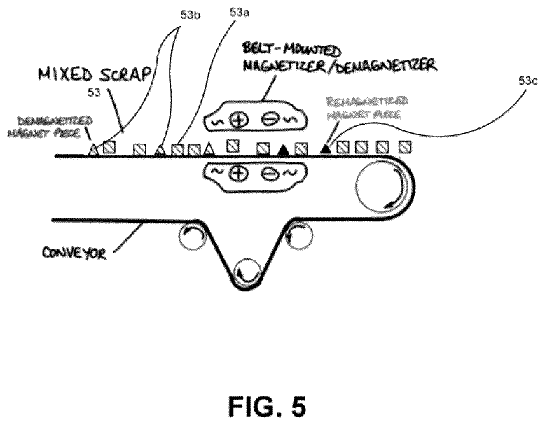

In one embodiment depicted in FIG. 5, the mixed scrap material 53, which may refer to mix scrap 23 and/or 33 of the above-referenced FIGS. is passed through a demagnetizing device arranged around a conveyor belt that applies a magnet field to the magnets to rearrange the polarity of the particles of the magnets. As depicted in FIG. 5, the demagnetizing device may include one or more pads installed, above, underneath, and/or on the sides of the conveyor belt. In a variation of the above embodiment, the mixed scrap material (23 or 33) is passed through an electric demagnetizing cylinder (e.g., a solenoid). The demagnetizing device may apply an oscillating, diminishing magnet field to demagnetize partially, mostly or substantially completely the mixed scrap 23 and/or 33. In embodiments, the demagnetizing device may include a rotating drum. The rotating drum may demagnetize (or at least partially reduce the magnetic field strength of) the magnets using magnetic fields. That is, the rotating drum may be magnetic or may otherwise be capable of applying a magnetic field.

In another variation of the above embodiment, the mixed scrap material is passed through a heating furnace. The heating furnace may apply a temperature ranging from about 50° C. to about 1,000° C., and more typically from about 200 to about 800° C., or more typically from about 300 to about 600° C., or even more typically from about 350 to about 450° C., based on the magnet composition of the mixed scrap material 53 and whether the demagnetization is to be permanent or reversible.

A demagnetization process, as described herein, demagnetizes at least most of the magnetized magnets in the mixed scrap. That is, the demagnetization process demagnetizes at least about 75%, or more particularly at least about 80%, or more particularly at least about 85%, or more particularly at least about 90%, or more particularly at least about 95%, or even more particularly at least about 99% by mass of the magnets comprising a magnetic field in the mixed scrap.

After demagnetization, the field strength of the magnets may be reduced by at least about 50%, or more particularly by at least about 60%, or more particularly by at least about 70%, or more particularly by at least about 80%, or more particularly by at least about 90%, or more particularly by at least about 95%, or even more particularly by at least about 99%. In embodiments, the mixed scrap, prior to demagnetization, includes magnetized magnets and magnets that have already been demagnetized (e.g., the net magnetic field of the magnets has been substantially reduced to zero or is negligible). The demagnetization process as described herein may have no further effect on the demagnetized magnets.

The resulting demagnetized material is then subjected to a downstream separation method. The downstream separation process may be able to distinguish between magnetic materials, allowing for the rejection of undesired ferrite magnets and/or steel and other ferromagnetic iron alloys. According to Embodiment 2, the downstream separation process exploits the magnetic properties of steel and other ferromagnetic iron alloys versus the magnets.

In the embodiment depicted in FIG. 5, re-magnetization of demagnetized magnets may be used. Ferromagnetic material can be magnetized by exposing it to a magnetic field. Material magnetized in this way may retain or recover at least in part and typically at least most of its magnetism permanently or temporarily (e.g., magnetism is retained for a length of time, or for an amount of use and may be based on storage, type of use, etc.).

In one embodiment, a mixed stream 53 of non-ferrous material containing an amount of unmagnetized (i.e., demagnetized) magnet material 53b is re-magnetized. The re-magnetized magnets 53c are then selectively pulled from the mixed stream 53 using a ferromagnetic gathering surface, as described above.

A magnetization device, as described herein, magnetizes (or re-magnetizes) at least most of the magnets in the mixed scrap 53. That is, the magnetization process magnetizes at least about 75%, or more particularly at least about 80%, or more particularly at least about 85%, or more particularly at least about 90%, or more particularly at least about 95%, or even more particularly at least about 99% by mass of the magnets in the mixed scrap 53.

The magnetizing device may restore the magnetic field strength of the magnets to at least about 60%, or more particularly at least about 65%, or more particularly at least about 70%, or more particularly at least about 75%, or more particularly at least about 80%, or more particularly at least about 85%, or more particularly at least about 90%, or more particularly at least about 65%, or even more particularly at least about 99% of the original field strength of the magnets prior to demagnetization. That is, the demagnetization and/or magnetization process are designed so as to reduce the permanent damage incurred by the magnets. The downstream separation processes may separate at least most, such as at least about 75%, or more particularly at least about 80%, or more particularly at least about 85%, or more particularly at least about 90%, or more particularly at least about 95%, or even more particularly at least about 99% by mass of the undesired ferrite magnets and/or steel and other ferromagnetic iron alloys from the desired magnets. Stated differently, a composition of a magnet concentrate produced by the downstream separation processes may comprise less than about 20%, or more typically less than about 15%, or more typically less than about 10%, or more typically less than about 5%, or even more typically less than about 1% by mass of undesired ferrite magnets and/or stee and other ferromagnetic iron alloys 1.

In embodiments, the magnetizing device may including a rotating drum. The rotating drum may be magnetic or may otherwise be capable of applying a magnetic field and may therefore (re) magnetize the magnets when they contact the rotating drum. The rotating drum may be equipped with an alternating magnetic field for magnetization. In embodiments, the rotating drum may be used to separate magnets from non-magnetic material (e.g., copper, steel and other ferromagnetic iron alloys). For example, magnets (such as those remagnetized by the drum) and non-magnetic material may contact the rotating drum and leave (e.g., fall off, scrapped off) the drum differently based on the differing attraction of the magnets and non-magnetic material to the rotating drum.

A single device may be used for both de-magnetization and re-magnetization, as described with reference to FIG. 5. In one example, a single de-magnetization/magnetization device may be followed by the downstream separation process and the separated magnets may be reprocessed through the de-magnetization/magnetization device to be magnetized. Alternatively, different devices may be used for de-magnetization versus re-magnetization. In one example, a de-magnetization device may be followed by the downstream separation process and the separated magnets may proceed forward through a magnetization device (separate from the de-magnetization device) for magnetization.

### Embodiment 3—A Method to Create a Magnet-Enriched Concentrate from Steel or Other Ferromagnetic Iron Alloys-Comprising Scrap by Milling, Re-Magnetizing/De-Magnetizing, Clumping, and Screening

In another embodiment, a method of creating a magnet-enriched concentrate from steel or other ferromagnetic iron alloys-comprising scrap is provided.

Steps of embodiment 3 exploit the physical properties of magnetic materials disclosed herein versus non-magnetic materials, and particularly steel and other ferromagnetic iron alloys. In one non-limiting example, magnets or pieces of magnets attract ferromagnetic material such as steel and other ferromagnetic iron alloys. If mixed scrap that contains magnets and steel and other ferromagnetic iron alloys is milled to a small size, the small pieces of magnets will attract pieces of steel and other ferromagnetic iron alloys and ferromagnetic iron dust to form a larger, loosely-bound, clump of material. The magnet material concentrates inside the clumps, while the surrounding matrix material becomes relatively depleted of magnets. A magnet concentrate can be produced by screening out the clumps.

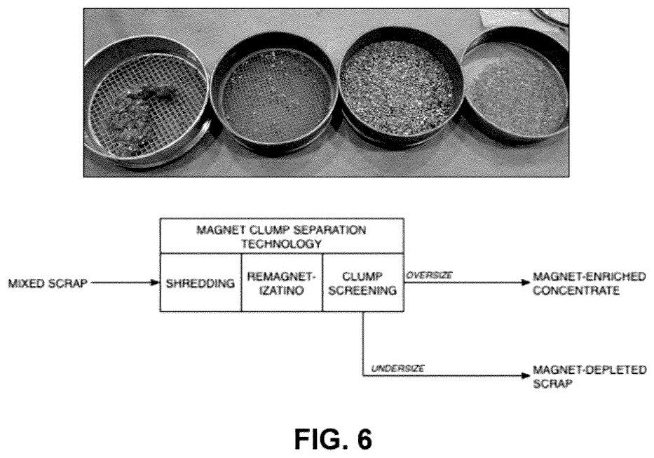

Steel and other ferromagnetic iron alloys are generally substantially less brittle than rare earth element-comprising materials. As such, when a size reduction process is applied, rare earth element-comprising materials will reduce in size faster and more uniformly than steel and other ferromagnetic iron alloys. That is, rare earth element-comprising materials will have a faster rate of size reduction than steel and other ferromagnetic iron alloys. Therefore, size reduction and separation techniques may be combined that exploit the rate of size reduction associated with rare earth element-comprising materials versus steel and other ferromagnetic iron alloys to achieve separation and produce a REE magnet concentrate. A schematic block diagram of an embodiment of the process is illustrated in FIG. 6.

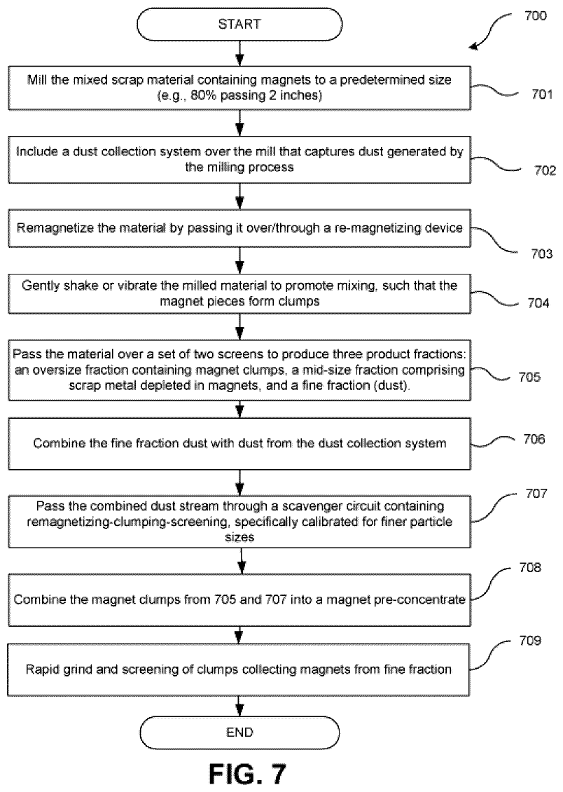

In one specific embodiment, a process 700 depicted in FIG. 7, may involve one or more of the illustrated steps to form a magnet concentrate from mixed scrap. The mixed scrap may comprise non-magnetized components and magnetized components. Non-magnetized components may refer to non-target materials 18 as described with reference to FIG. 1 and may include plastic, rubber, glass, non-magnetic metals such as aluminum and copper, steel and other ferromagnetic iron alloys, etc., or combinations thereof. Magnetized components may refer to target magnetic materials 24 as described with reference to FIG. 1 and may comprise rare earth element(s)-comprising magnets, such as but not limited to neodymium magnets, samarium cobalt magnets, cobalt and/or nickel-comprising magnets such as, but not limited to aluminum nickel cobalt magnets, or any combination thereof. The mixed scrap may comprise any ratio of non-magnetized components to magnetized components.

At step 701, the mixed scrap material comprising magnets is milled by a milling apparatus (e.g., a hammer mill) to a pre-determined size or for a pre-determined time. Components of the mixed scrap may be milled to achieve an average particle size ranging from about 5 inches and about 0.5 mm, or more particularly between about 4 inches and about 1 mm, or even more particularly between about 3 inches and about 1 cm. In a specific embodiment, the mixed scrap may be milled to achieve 80% passing of about 2 inches.

At step 702, a dust collection system may be utilized over the mill to capture dust generated by the milling process. The dust collection system may collect at least about 50%, or more particularly at least about 60%, or more particularly at least about 70%, or more particularly at least about 80%, or more particularly at least about 90%, or more particularly at least about 95%, or even more particularly at least about 99% by mass of the dust generated by the milling process.

In embodiments, milling may substantially de-magnetize magnets due to the force applied by the milling apparatus. In embodiments, between about 50% and about 100% by mass of the magnets in the mixed scrap may be de-magnetized, such that the magnetic field of the magnets is zero or negligible.

As an optional third step 703, the milled material may then be re-magnetized by passing it over or through a re-magnetizing device or by passing it over a magnetic field as described above. In one embodiment, the re-magnetizing device may be a magnet, which may be a strong magnet, such a neodymium magnet, and the step of re-magnetizing may include passing the material over a re-magnetizing device or the magnet.

The re-magnetizing device, as described herein, magnetizes (or re-magnetizes) at least some of the magnets in the mixed scrap.

An optional fourth step 704 involves shaking or vibrating the milled material to promote mixing, such that the magnet pieces form clumps. The shaking may be done in a gentle manner. The shaking may be performed by an agitator, a vibrating plate, a conveyor belt, etc. In some embodiments, the clumps may form without a separate shaking or vibrating step 704. The clumps may range in size and shape. In embodiments, the clumps may comprise an average diameter greater than about 2 inches, or more typically greater than about 3 inches, or more typically greater than about 4 inches, or more typically greater than about 5 inches, or more typically greater than about 6 inches. In embodiments, the clumps may comprise an average diameter ranging from about 2 inches to about 10 inches.

The clumps may comprise of magnetic components, such that the clumps may be composed of at least about 10%, or more typically at least about 30%, or more typically at least about 50%, or more typically at least about 80%, or more typically at least about 90%, or even more typically at least about 95% by mass target magnetic components. Stated differently, the clumps may be composed of less than about 90%, or more typically less than about 70%, or more typically less than about 50%, or more typically less than about 20%, or more typically less than about 10%, or more typically less than about 5% by mass non-magnetized and non-target magnetic components, such as steel and other ferromagnetic iron alloys.

At least about 10%, or more particularly at least about 30%, or more particularly at least about 50%, or more particularly at least about 80%, or more particularly at least about 90%, or more particularly at least about 95% by mass of the magnetized components of the mixed scrap may be captured in the clumps. Stated differently, less than about 90%, or more particularly at least about 70%, or more particularly at least about 50%, or more particularly at least about 20%, or more particularly at least about 10%, or more particularly at least about 5% by mass of the magnetized components do not form a clump and falls below the passing size of a first screen of step 705.

At a fifth step 705, the material comprising clumps and non-clumping components may then be passed over a set of screens progressively smaller in mesh size to produce several product fractions of progressively smaller components. In the depicted embodiment, two screens are used to produce three fractions. However, more generally, in other embodiments, N screens may be used to produce N+1 fractions. The order of these steps may be different than the example embodiment described.

In one specific embodiment, screens are used to produce three product fractions, namely: an oversize fraction containing magnet-comprising clumps; a mid-size fraction comprising scrap metal depleted in magnets; and a fine fraction (dust).

In embodiments, one or more of the screen sizes may be selected based on the average size of the clumps and/or non-clumping components. The first screen may capture at least most (i.e., at least about 75%, or at least about 80%, or at least about 85%, or at least about 90%, or at least about 95%, or at least about 99%) of the clumps by mass. The first screen may allow at least most of the non-clumping components to pass to the second screen. That is, the composition of the material captured by the first screen may comprise less than about 20%, or more typically less than about 15%, or more typically less than about 10%, or more typically less than about 5%, or more typically less than about 1% non-clumping components by mass. Stated differently, the composition of the material captured by the first screen comprises greater than about 80%, or more typically greater than about 85%, or more typically greater than about 90%, or more typically greater than about 95%, or more typically greater than about 99% magnet-comprising clumps by mass. Step 705 may remove at least 50%, or at least about 60%, or at least about 70%, or at least about 80%, or at least about 90%, or at least about 95%, or at least about 99% of the non-magnetized components by mass, such as steel and other ferromagnetic iron alloys, from the mixed scrap.

The oversize fraction containing magnet-comprising clumps may have a purity of magnet content between about 1% and about 99%, or more particularly between about 5% and about 90%, or more particularly between about 10% and about 80% by mass. Stated differently, the oversize fraction containing magnet-comprising clumps may comprise less than about 99%, or less than about 80%, or less than about 40%, or less than about 30%, or less than about 20%, or less than about 1% by mass non-magnetized components, such as steel and other ferromagnetic iron alloys.

The mid-size fraction may also comprise less than about 99%, or less than about 80%, or less than about 50%, or less than about 30%, or less than about 10%, or less than about 1% by mass magnetized components. The mid-size fraction may comprise at least about 1%, or at least about 30%, or at least about 60%, or at least about 80%, or at least about 90%, or at least about 99% by mass of the steel and other ferromagnetic iron alloys in the mixed scrap.

The composition of the fine fraction dust may comprise greater than about 10%, greater than about 30%, greater than about 70%, greater than about 80%, greater than about 90%, greater than about 99% magnet components by mass, which may have been de-magnetized in the milling process.

In a non-limiting embodiment, the first screen comprises a mesh with a 80% passing (Pac) greater than about 0.5 inches, or more typically greater than about 1 inch, or more typically greater than about 2 inches. The first screen may comprise a P₈₀ between about 0.5 to about 5 inches. The second screen comprises a mesh with P₈₀ of less than about 2 inches, or more typically less than about 1 inch, or more typically less than about 0.5 inches.

The process 700 may further include an optional sixth step 706 to combine the fine fraction dust with dust from the dust collection system. As a seventh step 707, the process 700 then passes the combined dust stream through a scavenger circuit that may also include re-magnetizing, clumping, and screening steps, specifically calibrated for finer particle sizes, to collect remaining magnetic components from the dust.

As an optional eighth step 708, the magnet clumps from step 705 and step 707 may then be combined into a magnet pre-concentrate. Magnet pre-concentrate may refer to magnet clumps from step 705, from step 707, or the combination of the magnet clumps from step 705 and 707.

In an optional step, the magnetic pre-concentrate may be de-magnetized by methods disclosed herein, such as by heating, to deplete the magnetic field of the magnetic components in the clumps to about zero or a negligible value. In some embodiments, de-magnetizing the pre-concentrate may serve to break up the clumps.

At step 709, the physical differences between the magnetic components of the present disclosure and the non-magnetic components within the clumps, such as steel and other ferromagnetic iron alloys, may be utilized to further remove the non-magnet components to form a magnet concentrate. For example, step 709 may exploit the size reduction rate discrepancies between the magnetic components and the non-magnetic components. Specifically, the magnetic components are less brittle than the non-magnetic components, namely steel and other ferromagnetic iron alloys, and as such, the magnetic components will have a faster size reduction rate.

Step 709 may include inputting the magnet pre-concentrate to a further size reduction apparatus, such as a rapid grind or mill apparatus (e.g., ball mill, rod mill, or a combination thereof), followed by screening. As the magnetic components have a faster rate of reduction, the magnetic components reduce in size and pass through one or more screens for collection more quickly than the non-magnet components. The non-magnet components will then collect on the surface of the one or more screens.

Screening may include passing the reduced components over one or more screens to separate the magnet components from the non-magnet components. As the magnetized components typically reduce in size more quickly than the non-magnet components, the magnetized components will pass though the one or more screens, and the non-magnet components will remain on the surface of the screens.

Step 709, produce a magnet concentrate of a purity of at least about 50%, or at least about 70%, or at least about 80%, or at least about 85%, or at least about 90%, or at least about 95%, or at least about 99% magnetic components by mass. Stated differently, the magnet concentrate may comprise less than about 50%, or less than about 30%, or less than about 15%, or less than about 10%, or less than about 5%, or less than about 1% non-magnetized components by mass, such as steel and other ferromagnetic iron alloys.

Additionally, or alternatively, a method may be used with or without the above mentioned includes refining, demagnetizes the agglomerations, and while the material is at temperature, the method separates the steel and other ferromagnetic iron alloys from the magnets using magnetic separation. Conducting magnetic separation at temperature exploits the differences in magnetic attraction of steel and other ferromagnetic iron alloys and magnets at high temperatures and can be used to concentrate the material.

As noted above, all or only a subset of the illustrated steps of process 700 may be undertaken.

One or more steps of Embodiment 3 may be combined with one or more of Embodiments 1 and 2. For example, methods of Embodiment 1 (i.e., FIGS. 2 to 4) may be employed to separate magnet clumps from non-magnetic materials. The methods of Embodiment 1 may be used in place of or in combination with step 705 of FIG. 7. It should be understood that magnetic clump separation (from non-magnetic material) may be performed manually (e.g., by-hand, via screening) or via autonomation (e.g., methods described with reference to FIGS. 2 to 4).

### Embodiment 4—Paramagnetic Upgrading of Mixed Oxides to Produce a REE Oxide Concentrate

Iron oxide and rare earth element oxides (REE oxides) are paramagnetic, meaning they are weakly attracted to a magnetic field. It is possible to separate different paramagnetic materials from one other by exploiting their differing magnetic susceptibilities (Xm) using a very strong magnetic field. Table 1, below, lists a measure of magnetic susceptibilities of various materials.

TABLE 1
Measure of magnetic
susceptibilities of various materials.

| | Xm, 10⁻⁶ | |
|---|---|---|
| Material | cm³ mol⁻¹ | Remarks |
| Iron metal | Infinite | Ferromagnetic |
| Iron(II) oxide | +7,200 | Paramagnetic |
| Neodymium metal | +5,930 | Paramagnetic |
| Neodymium oxide | +10,200 | Paramagnetic |

### Embodiment 5—Mechanical Sorting of Magnets from Mixed Scrap Using Magnetic Field Detection

As is well known, while permanent magnets produce a magnetic field, steel and other ferromagnetic iron alloys, by itself, does not. In one embodiment, these properties are utilized as follows. An array of magnetic field sensors (e.g., magnometer or Gauss meter) is provided to build a topographic map of magnetic field strength of a mixed scrap on a moving conveyor. Signal processing is then employed to analyze images of the mixed scrap, and to infer locations of magnets within a mixed scrap containing magnetic components and steel and other ferromagnetic iron alloys fragments. A mechanical method such as an air jet may then be used to segregate the magnets based on the inferred locations.

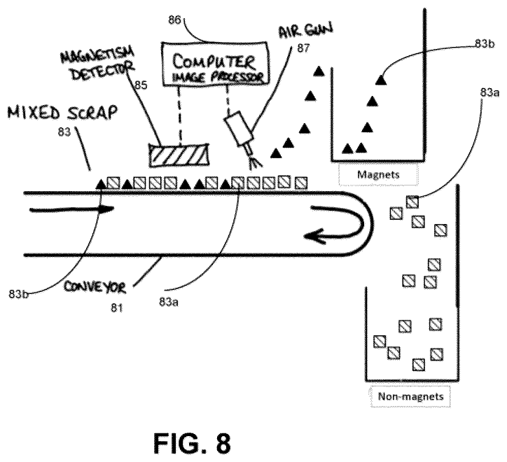

One specific embodiment includes four parts for magnet sorting: stimulation, sensor, signal processing, and mechanical sorting. FIG. 8 depicts one specific embodiment. Mixed feed material 83 is moved in a thin layer along a conveyor belt 81 and images of the material are captured by a detector or a sensor 85 similar to digital camera, that is capable of capturing and representing the magnetic field within its field of view.

A computing device 86 executing a proprietary software algorithm is then used to processes the images to identify the location of the magnets. A mechanical device 87, which may be an air gun in this embodiment, is then employed to pick out the desired magnetic components. A subsystem comprising the sensor 85, computing device 86 including the software may be formed as a stand-alone system. The stand-alone subsystem above may be deployed exclusively for internal use as part of a conveyor, or alternately may be built as a separate equipment package suitable for use by scrapyards. This embodiment may require a detector having a sensor capable of representing magnetic fields. The associated signal processing may present difficulties, as the raw magnetic field map may appear to resemble undulating hills rather than clear peaks. Likewise, a wide distribution of small magnet particles or dust may generate a broad, weak signal that might be difficult to distinguish from background noise. Persons of skill in the art of magnetic fields expect that the signals obtained from such a setup would be very noisy. Further, ferrous material may be magnetically attracted to the magnets and remain stuck during said mechanical sorting, resulting in high contamination of the magnet concentrate.

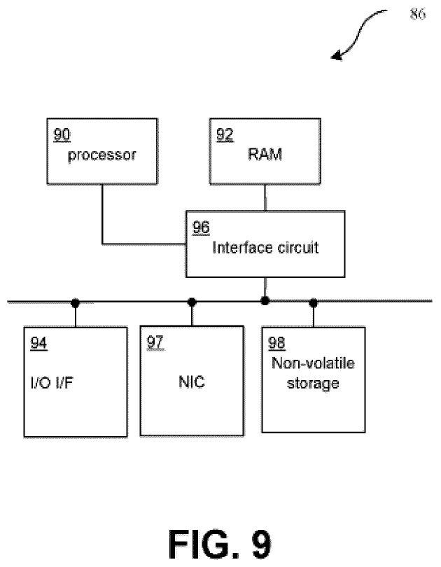

FIG. 9 shows various physical elements of computer system 86 of FIG. 8. As shown, computer system 86 has a number of physical and logical components, including a processor 90, memory 92 which may be in the form of random access memory (“RAM”), an interface circuit 96, an input/output (“I/O”) interface 94, a network interface 97, non-volatile storage 98. Interface circuit 96 enabling processor 90 to communicate with the other components. Processor 90 executes at least an operating system, and a proprietary software noted above for analyzing images of magnetic fields or related properties captured by sensor 85. Memory 92 provides relatively responsive volatile storage to processor 90. I/O interface 94 allows for input to be received from one or more devices, such as a keyboard, a mouse, etc., and outputs information to output devices, such as a display and/or speakers. Network interface 97 permits communication with other computing devices over computer networks such as Internet. Non-volatile storage 98 stores the operating system and programs, including computer-executable instructions for implementing the software. During operation of computer system 86, the operating system, the programs and the data may be retrieved from non-volatile storage 98 and placed in memory 92 to facilitate execution.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

Any of embodiments 1 through 5 may be used in combination with one another to produce a target magnetic material, such as target magnetic material 24 described with reference to FIG. 1.

### Overall Mechanical Process

In one embodiment, an overall process combines a series of individual physical processing steps in a unique combination that is able to output an enriched magnet concentrate from mixed scrap material.

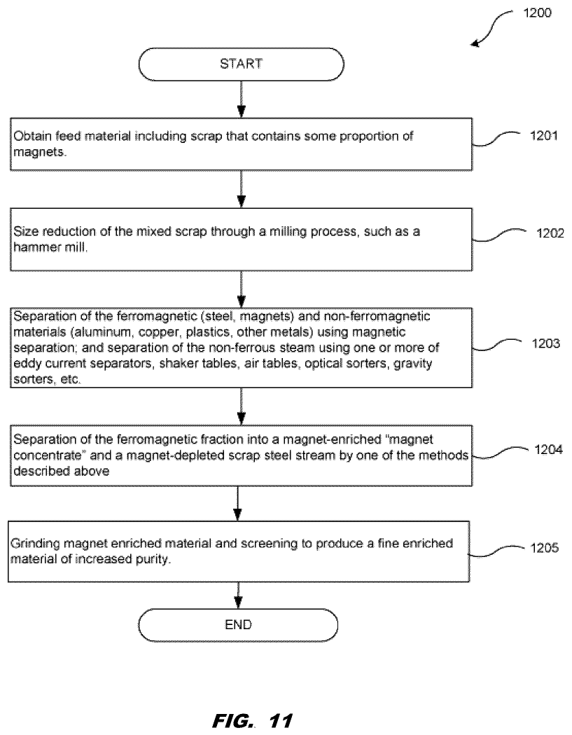

The process 1200 is summarized in FIG. 11 and comprises the following steps:

At step 1201, feed material comprising mixed scrap that contains some proportion of magnets is obtained. As described herein, the magnets may comprise rare earth element-comprising magnets, such as but not limited to, neodymium magnets, samarium cobalt magnets, cobalt and/or nickel-comprising magnets such as, but not limited to aluminum nickel cobalt magnets, or any combination thereof. The feed material may further include non-REE-comprising magnets, and non-magnetic materials including non-magnetic metals such as aluminum, copper, and gold, and other materials such as water, plastic, wood, rubber, etc.

The composition of the feed material may comprise between about 1% and about 90%, or more typically between about 2% and about 10%, or even more typically between about 3% and about 5% by mass rare-earth element comprising magnets. The composition of the feed material may comprise between about 10% to about 90%, or more typically between about 20% and 80%, or even more typically between about 30% and 70% by mass non-magnetic materials.

At step 1202, the size of the components of the mixed scrap is reduced through a milling process, such as a hammer mill, as described in step 701 of Embodiment 3. Components of the mixed scrap may be milled to achieve an average particle size ranging from about 5 inches and about 0.5 mm, or more particularly between about 4 inches and about 1 mm, or even more particularly between about 3 inches and about 1 cm.

Optionally, at step 1203 separation of the ferromagnetic (e.g., steel and other ferromagnetic iron alloys, magnets) and non-ferromagnetic materials (e.g., aluminum, copper, plastics, other metals) using magnetic separation is undertaken and further separation of the non-ferrous steam is achieved using one or more of eddy current separators, shaker tables, air tables, optical sorters, gravity sorters, etc., as described in more detail with reference to embodiments 1 and/or 2. Step 1203 may separate at least most (i.e., at least about 75%, at least about 80%, at least about 85%, at least about 90%, at least about 95%, at least about 99% by mass) of the non-ferromagnetic from the ferromagnetic materials. The separated non-ferromagnetic materials may comprise less than about 40%, or more typically less than about 30%, or more typically less than about 25%, or more typically less than about 20%, or more typically less than about 15%, or more typically less than about 10%, or more typically less than about 5%, or more typically less than about 1% by mass ferromagnetic material. More specifically, the separated non-ferromagnetic materials may comprise less than about 40%, or more typically less than about 30%, or more typically less than about 25%, or more typically less than about 20%, or more typically less than about 15%, or more typically less than about 10%, or more typically less than about 5%, or more typically less than about 1% magnets by mass.

The separated ferromagnetic material may comprise less than about 40%, or more typically less than about 30%, or more typically less than about 25%, or more typically less than about 20%, or more typically less than about 15%, or more typically less than about 10%, or more typically less than about 5%, or more typically less than about 1% non-ferromagnetic material by mass.

The composition of the separated ferromagnetic material may comprise less than about 50%, or more typically less than about 40%, or more typically less than about 30%, or more typically less than about 25%, or more typically less than about 20%, or more typically less than about 15%, or more typically less than about 10%, or more typically less than about 5%, or more typically less than about 1% by mass non-rare earth comprising magnets (e.g., cobalt and/or nickel-comprising magnets such as, but not limited to aluminum nickel cobalt magnets), rare earth comprising magnets (e.g., samarium cobalt magnets, neodymium magnets), or both. Stated differently, the composition of the separated ferromagnetic material may comprise at least about 50%, or more typically at least about 60%, or more typically at least about 70%, or more typically at least about 75%, or more typically at least about 80%, or more typically at least about 85%, or more typically at least about 90%, or more typically at least about 95%, or more typically at least about 99% by mass steel and other ferromagnetic iron alloys.

At step 1204, the ferromagnetic fraction is separated into a target magnetic materials-enriched “magnet concentrate” and a non-target magnetic materials-depleted scrap steel and other ferromagnetic iron alloys stream by one of the methods described above (e.g., size reduction and screening, de-magnetization and re-magnetization, etc.) in the FIGS. 1 to 12 and can used in any order. Step 1204 may separate at least most (i.e., at least about 20%, at least about 60%, at least about 85%, at least about 90%, at least about 95%, at least about 99% by mass) of the non-target magnetic materials from the target magnetic materials. The separated non-target magnetic materials may comprise less than about 40%, or more typically less than about 30%, or more typically less than about 25%, or more typically less than about 20%, or more typically less than about 15%, or more typically less than about 10%, or more typically less than about 5%, or more typically less than about 1% by mass target magnetic materials.

The separated target magnetic material may comprise less than about 60%, or more typically less than about 30%, or more typically less than about 25%, or more typically less than about 20%, or more typically less than about 15%, or more typically less than about 10%, or more typically less than about 5%, or more typically less than about 1% non-target magnetic materials by mass.

The composition of the separated target magnetic material may comprise of at least about 10 to 80%, or more typically 20 to 60% steel and other ferromagnetic iron alloys by mass. Stated differently, the composition of the separated target magnetic material may comprise at least about 5 to 80%, or more typically at least about 15 to 60%, or more typically at least about 25 to 50% by mass non-rare earth comprising magnets (e.g., cobalt and/or nickel-comprising magnets such as, but not limited to aluminum nickel cobalt magnets), rare earth comprising magnets (e.g., samarium cobalt magnets, neodymium magnets), or both.

The composition of the separated non-target magnetic material may comprise steel and other ferromagnetic iron alloys, plastics, glass, aluminum, copper, gold, and other non-magnetic metal elements and compounds, wood, etc.

Step 1205 involves grinding target magnetic enriched material and screening to produce a magnet concentrate of high purity, as described in step 709 of Embodiment 3.

Step 1205 may remove at least 50%, or at least about 60%, or at least about 70%, or at least about 80%, or at least about 90%, or at least about 95%, or at least about 99% by mass of the remaining non-magnetized components (e.g., steel and other ferromagnetic iron alloys, plastics, glass, aluminum, copper, gold, and other non-magnetic metal elements and compounds, wood, etc.) from the target magnetic enriched material.

The magnet concentrate may have a purity of at least about 30%, or at least about 50%, or at least about 80%, or at least about 90%, or at least about 95%, or at least about 99% by mass magnetic components (e.g., non-rare earth element magnets, rare earth element-comprising magnets). State differently, the magnet concentrate may comprise less than about 70%, or less than about 50%, or less than about 20%, or less than about 10%, or less than about 5%, or less than about 1% by mass non-magnetized components, such as steel and other ferromagnetic iron alloys.

The process 1200 then terminates.

### Chemical System/Processes

Some embodiments of the system disclosed herein, although characterized as chemical processes, may contain steps or processes that also exploit physical properties of the material components. A description of each of the process constituents is provided below, although the order and use of the process constituents may change.

Certain specific terms for steps or processes used throughout the present description may be read and understood as follows, unless the context indicates otherwise.

### Grinding:

To facilitate reaction kinetics, magnet material (e.g., magnet concentrate from Step 1205) is comminuted and screened to ensure a target particle size, such as 80% passing (or P₈₀ size) between about 1 to about 5000 microns, or more typically between about 5 to about 1000, or more typically between about 10 to about 500 microns, or more typically between about 50 to about 250 microns, or more typically about 100 microns. Comminution may be performed by a hammer mill, ball mill, rod mill, etc.

Comminution typically generates heat and for some materials, such as neodymium magnets or other metals, the attendant dust particles produced may be flammable and/or explosive. To eliminate or at least reduce this risk several methods may be used including but are not limited to the addition of water, cutting fluids, dry ice, nitrogen gas, argon, and carbon dioxide or a combination thereof. The use of water and dry ice may act to reduce the heat below the temperature of combustion, and the use of the gases may act to limit the availability of oxygen, while the use of dry ice may act to reduce heat and limit the availability of oxygen. In some embodiments, the dust may be collected for further processing/recycling.

### Washing:

A valuable feed source for magnet recycling includes swarf, which is a manufacturing waste product. Swarf is typically mixed with a liquid used as a cutting or cooling aid, such as a cutting oil. Swarf may be washed using, water, heated water, surfactants, such as but not limited to sodium dodecylsulfate, Alconox®, Alcojet®, Detergent 8, and Detonox®, and/or other reagents including but not limited to: dichloromethane, that breakdown organic material. Washing procedures have been tested and efficacies range from removing about 70% to about 100% of the entrained cutting liquid.

Washing may remove at least most (i.e., at least about 75%, at least about 80%, at least about 85%, at least about 90%, at least about 95%, at least about 99% by mass) of the oil from the swarf.

Specifically, magnet manufacturing swarf involves metal pieces soaked in oil and water. This is then cleaned before it can be fed to the process of FIG. 1.

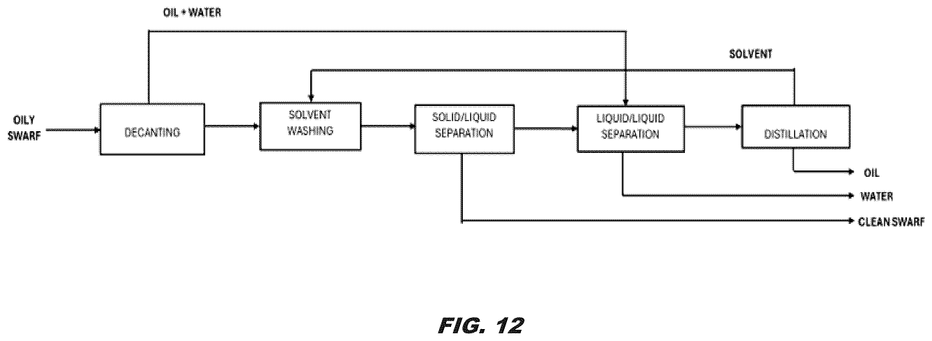

In the embodiment depicted in FIG. 12, during the cleaning process, a volatile solvent or water (individually and collectively referred to as “solvent”) is mixed with the swarf to dissolve and/or separate all oil. The swarf is then separated from the solvent by settling and decantation, followed by a final wash with more solvent.

The oil-loaded solvent is then distilled to recover and recycle the solvent, and the residual oil is sold or disposed.

Non-limiting examples of a volatile solvent includes trichloroethylene and d-Limonene and other surfactants, such as but not limited to sodium dodecylsulfate, Alconox®, Alcojet®, Detergent 8, and Detonox®, and/or other reagents including but not limited to: dichloromethane, that breakdown organic material.

FIG. 12 depicts a non-limiting example of washing, according to embodiments disclosed herein.

### Roasting:

To facilitate the removal of impurities, the magnet material may be roasted at a temperature that varies between about 150° C. and about 1000° C., or more typically between about 200° C. and about 900° C., or more typically between about 300° C. and about 800° C., or even more typically between about 400° C. and about 700° C. to alter the oxidative state of one or more impurities in the magnet material. Specifically, oxidative roasting converts at least a portion of the impurities to oxides. Roasting, according to embodiments of the present disclosure, may achieve 100% oxidation of the magnet material. Other chemicals, such as but not limited to lime could be added to adsorption any harmful chemicals during this process. The magnet material may be roasted between about 30 minutes to about 6 hours, or more typically between about 45 minutes to about 3 hours, or more typically between about 1 hour to about 2 hours. It is noted that roasting may occur over any amount of time to achieve a desired oxidation level of the input magnet material. In embodiments, roasting may be performed with an air flow about 1 to 8.5 liters per minute (LPM). Oxidation roasting equipment may include a rotary kiln, a multichamber baking furnace, fluidized baking furnace, and the like.

### Leaching:

The leaching process utilizes a lixiviant, which may include but is not limited to: hydrochloric acid, sulphuric acid, nitric acid, formic acid, citric acid, and/or other organic acids or a combination thereof. The lixiviant may be selected based at least in part on the composition of the magnet material in the swarf and/or magnet concentrate produced above with reference to the mechanical process.

In embodiments, the pulp density (i.e., the solid mass to liquid mass ratio) of the magnet material to lixiviant ranges from about 1% to about 30%, or more typically from about 3% to about 25%, or even more typically from about 5% to about 20%, where the percents are given as a solid mass to total solid plus liquid mass percentages.

In embodiments, the pH of the lixiviant may be less than about pH 5, or more typically less than about pH 4, or more typically less than about pH 3. The pH of the lixiviant may range from about pH 0 to about pH 2.5.

The magnet material may be contacted with the lixiviant and allowed to react for about 1 to about 8 hours, and more typically from about 2 to about 7 hours, or even more typically for about 3 to about 6 hours.

The temperature of the leach process may range from about 10 to about 110° C., and more typically from about 50 to about 100° C., and more typically from about 60 to about 90° C.

To date, leaching tests have demonstrated extraction efficiencies of up to about 90%, or more typically up to about 95%, or more typically up to about 99%, or more typically up to about 100% by mass of the contained critical minerals, that includes rare earth elements, cobalt, and nickel, by controlling temperature, reaction time, and using an oxidizing agent. Control of some or all of these operating parameters may be used or not used.

The resulting pregnant leach solution composition may vary depending on the type of feed material. In a particular example, the solution may comprise between about 0.1 g/L and the solubility limit of the REEs in the pregnant leach solution. In embodiments, the solution may comprise between about 20 g/L REEs, between about 1 g/L and about 100 g/L iron, between about 0.1 g/L and about 2 g/L boron, between about 0.1 g/L and about 15 g/L cobalt, between about 0.01 g/L and about 5 g/L nickel, and about 0.1 g/L and about 2 g/L other impurities (e.g., aluminum, zinc, copper).

### Iron Removal:

Iron and other impurities may be precipitated from the process solution by adjusting the solution pH with calcium oxide, calcium hydroxide, calcium carbonate, magnesium oxide, magnesium hydroxide, magnesium carbonate, sodium hydroxide, or other alkaline reagents or minerals, or a combination thereof in an oxidative environment (i.e., in the presence of oxygen) achieved by the use of air, oxygen gas, or hydrogen peroxide, mixture of sulfur dioxide with oxygen or air gasses, permanganate, or other known oxidants in the industry or a combination thereof. The addition of copper ions and the use of solvent extraction may also be applied.

Specifically, iron can be removed by solvent extraction and precipitation as goethite or hematite.

In embodiments, the process solution may comprise an initial iron concentration ranging from about 1 g/L to about 100 g/L, and more typically from about 5 g/L to about 90 g/L, and more typically from about 10 g/L to about 75 g/L, and more typically from about 15 g/L to about 50 g/L.

The process solution may be adjusted to a pH less than about pH 6, and more typically less than about pH 5.5, and more typically less about pH 5.0, and even more typically less than about pH 4.5. The process solution may be adjusted to a pH between about pH 1.5 and pH 4.5, and more typically from about pH 1.5 to about pH 4.0, and even more typically from about pH 1.5 to about pH 3.5.

In embodiments, about a 50 wt. % hydrogen peroxide solution is added to the process solution to achieve a concentration in solution ranging from about 2% to about 40%, or more typically from about 5% to about 35%, or more typically from about 10% to about 30% by mass.

The type and amount of alkaline reagent added to the process solution may be based on pH of the alkaline reagent, current pH of the process solution, and desired pH of the process solution to precipitate at least a portion of the iron in solution.

In embodiments, a copper comprising solution, such as copper sulphate, may be added to the process solution in an amount ranging from about 20 g/L to about 150 g/L, and more typically from about 25 g/L to about 125 g/L, and even more typically from about 30 g/L to about 100 g/L.

The temperature of the iron removal process may range from about 10 to about 110° C., and more typically from about 50 to about 100° C., and more typically from about 60 to about 90° C.

The iron removal process may have a reaction time ranging from about 1 hour to about 15 hours, and more typically from about 2 to about 12 hours, and even more typically from about 3 to about 10 hours.

To date, test work has achieved removal of up to about 90%, or more typically up to about 95%, or more typically up to about 99%, or even more typically up to about 99.99% by mass iron from solution. In embodiments, one or more other impurities may precipitate out of solution with the iron, including aluminum, copper, zinc, or a combination thereof.

In the iron removal process of the present disclosure results in less than about 15%, or more typically less than about 10%, or more typically less than about 9%, or more typically less than about 8%, or even more typically less about 5% by mass loss of trace rare earth elements. That is, less than about 5% by mass of rare earth elements present in solution precipitate out of solution with the iron.

Following iron precipitation, the process solution may comprise less about 10%, or more typically less than about 5%, or more typically less than about 1%, or more typically less about 0.5% by mass iron and, in some embodiments, other impurities such as aluminum, copper, zinc, or a combination thereof. In embodiments, the process solution may be substantially free of iron and, in some embodiments, other impurities such as aluminum, copper, zinc, or a combination thereof.

Iron removal targets iron precipitation while non-iron metals remain in solution, particularly boron, cobalt, and nickel. In embodiments, less than 25%, or more particularly less than 20%, or more particularly less than 15%, or more particularly less than 10%, or more particularly less than 5%, or more particularly less than 1% by mass of the boron, cobalt, and nickel present in the pregnant leach solution precipitate out during iron removal.

The resulting process solution following iron removal may comprise between about 0.1 g/L and the solubility limit of the REEs in the resulting process solution. In embodiments, the solution may comprise between about 50 g/L REEs, between about 0.001 g/L and about 5 g/L iron, between about 0.1 g/L and about 2 g/L boron, between about 0.1 g/L and about 14 g/L cobalt, between about 0.01 g/L and about 5 g/L nickel, and about 0.1 g/L and about 2 g/L other impurities (e.g., aluminum, zinc, copper) based at least in part on the composition of the swarf and/or magnet concentrate produced above.

### Oxalate Precipitation:

The production of a rare earth element (REE) material may be achieved by precipitation as a salt, such as an oxalate or a carbonate. Oxalate precipitation may occur after the precipitation of one or more impurities, such as iron, aluminum, copper, zinc, or a combination thereof. Such a precipitation may target a high purity REE-comprising product by dosing the solution with about 50% to 500%, or more typically with about 55% to about 250%, and even more typically with about 60% to about 200% the stoichiometric addition of the precipitating reagent relative to the target precipitant (e.g., REEs).

Oxalate precipitation may occur at a pH ranging from about pH 0.5 to about pH 5.5, and more typically from about pH 1.0 to about pH 5.0.

Oxalate precipitation may occur at a temperature up to about 100° C., or more typically up to about 90° C., or more typically up to about 80° C., or more typically up to about 70° C., or more typically up to about 60° C., or even more typically up to about 50° C.

The oxalate precipitation reaction may occur over 5 minutes to about 2 hours.

To date, laboratory work has achieved between about 50% and about 100% recovery of REEs from the process solution. That is, following oxalate precipitation, the process solution may comprise about 50% to about 0% REE.

The REE oxalate precipitant comprises a purity of at least about 90%, or more typically at least about 95%, or more typically at least about 99%, or even more typically at least about 99.5% by mass REEs. That is, the REE precipitant comprises less about 10%, or more typically less about 5%, or more typically less about 1%, or even more typically less about 0.5% by mass non-rare earth elements and compounds.

In one embodiment, a process for selective precipitation of rare earth oxalates from iron-rich leach solutions involves controlling oxalate and/or oxalic acid addition to the process solution. When magnet-comprising material is leached in acid, the resulting pregnant leach solution may comprise many metals, including REEs, iron, aluminum, copper, nickel, and others. The separation of these metals from one another, and particularly the separation of the REEs from non-REE metals, is desirable to ensure the quality of the REE product meets predefined specifications for their intended application.

One method of rare earth separation is selective REE oxalate precipitation. With this process other metals also precipitate as oxalates, requiring the resultant contaminated product to be further refined.

In the course of experimental work, it was observed that REE oxalates tend to precipitate first, followed by iron oxalates. In one embodiment of a process utilizing this observation, iron may be rejected by carefully controlling the stoichiometric amount of oxalate and/or oxalic acid that is added to the leach solution to nearly match, or be slightly above, relative to the amount of REEs. The embodiment involves pairing the monitoring of REE concentration in the leach solution with (near) exact dosing of oxalate and/or oxalic acid, such that REE precipitation is increased/maximized and iron precipitation is reduced/minimized. That is, the selective precipitation of rare earth oxalates comprises adding a stoichiometric amount of oxalate or oxalic acid such that as much REEs are precipitated as possible before iron and other impurities (e.g., aluminum, zinc, copper) begin precipitating out of solution. Such selective precipitation may leave some REEs in the process solution but the resulting REE oxalate precipitant will be highly pure.

In embodiments, selective REE oxalate precipitation converts at least most (i.e., at least about 75%, at least about 80%, at least about 85%, at least about 90%, at least about 95%, at least about 99%, at least about 99.5% by mass) of the REEs from the process solution to REE oxalates which precipitate out of the process solution. That is, less than about 25%, or about 20%, or about 15%, or about 10%, or about 5%, or about 1%, or about 0.5% by mass of the REEs may remain in the process solution following the selective REE oxalate precipitation.

The composition of the resulting oxalate precipitant may comprise at least about 75%, or more typically at least about 80%, or more typically at least about 85%, or more typically at least about 90%, or more typically at least about 95%, or more typically at least about 95.5%, or more typically about 100% by mass REE oxalates. That is, the resulting oxalate precipitant may comprise less than about 25%, or more typically less than about 20%, or more typically less than about 15%, or more typically less than about 10%, or more typically less than about 5%, or more typically less than about 1%, or more typically less than about 0.5%, or even more typically about 0% by mass non-REE oxalates or compounds (e.g., aluminum, iron, copper, zinc, cobalt, boron, nickel, etc.).

In other embodiments, the stoichiometric amount of oxalate or oxalic acid added to the process solution may be selected to recover substantially all (i.e., at least about 90%, at least about 95%, at least about 99%, at least about 99.5%, at least about 99.9% by mass) of the REEs from the product solution. That is, less than about 10%, or about 5%, or about 1%, or about 0.5%, or about 0.1% by mass of the REEs may remain in the process solution following the oxalate precipitation.

In such embodiments, however, the resulting oxalate precipitate may comprise one or more non-REE impurities such as iron, aluminum, zinc, copper, etc., or combinations thereof. The resulting oxalate precipitant may comprise less than about 50%, or more typically less than about 40%, or more typically less than about 30%, or more typically less than about 25%, or more typically less than about 20%, or more typically less than about 15%, or more typically less than about 10%, or more typically less than about 5% by mass non-REE oxalates or compounds (e.g., aluminum, iron, copper, zinc, cobalt, boron, nickel, etc.).

### Calcination:

The conversion of oxalate and/or carbonates in the oxalate precipitant to an oxide is achieved by calcination. Calcination is the thermal treatment of a solid chemical compound whereby the compound is raised to high temperature without melting under restricted supply of ambient oxygen, to remove impurities or volatile substances. Specifically, the oxalate precipitate may be subjected to calcination for impurity removal, such as but not limited to nickel, cobalt, and iron oxalates, to recover recycled mixed rare earth oxide (rMREO).

The calcination may be carried out at a temperature of about 150° C. to about 1200° C., in presence of air, with a reaction time ranging from 30 minutes to 8 hours.

This process may include selective calcination by targeting temperatures associated with the conversion of specific species, such as impurities.

In an embodiment, selective calcining of a mixed oxalate precipitate is followed by steps for separating impurities. As described above, REEs can be recovered from a leach solution by oxalate precipitation. This mixed oxalate precipitation process, even if tightly controlled, may produce a product that contains some impurities (e.g., iron, aluminum, zinc, copper, boron, cobalt, nickel). The conventional approach to purify the oxalate is to calcine substantially all of the components of the mixed oxalate to oxides and re-leach the mixed oxide, followed by hydrometallurgical purification.

Selective calcination of a mixed oxalate is a novel alternative that eliminates the need for re-leaching that may achieve the same result at lower cost. Nickel, cobalt, and iron oxalates thermally decompose at a lower temperature than rare earth oxalates. As such, selective calcination may include calcining the mixed oxalate at a low temperature range to first convert the non-REE impurities to an oxide while the REE oxalates remain as oxalates. The low temperature range may include temperatures less than about 650° C., such that the first temperature range may comprise about 150° C. to about 650° C. In some embodiments, the calcination process may include incrementally increasing the temperature within the low temperature range to selectively convert oxalates within the impurities to oxides. In a non-limiting example, calcination may occur at a first low temperature range from about 150° C. to about 300° C. for a duration ranging from about 30 minutes to about 8 hours to convert a first oxalate impurity, then the temperature may be increased to a second low temperature range from about 300° C. to about 500° C. for a duration ranging from about 30 minutes to about 8 hours to convert a second oxalate impurity, then the temperature may be increased to a third low temperature range from about 500° C. to about 650° C. for a duration ranging from about 30 minutes to about 8 hours to convert a third oxalate impurity. It should be understood that this example is provided for understanding and the present disclosure is not so limited. The step-wise increase of temperature during calcination may include any number of increases in temperature ranges, over any time duration, etc.

Following calcination within the low temperature range, the calcination process may then include increasing the temperature to within a high temperature range from about 30 minutes to about 8 hours to convert the REE oxalates to REE oxides. The high temperature range may include about 650° C. to about 1200° C. Calcination of the REE oxalates may similarly include step-wise increases in temperature as described with reference to the impurity calcination.

In embodiments, the differing properties (e.g., solubility, calcination, magnetism) of the REE oxalates or carbonates and/or REE oxides versus impurity oxides can then be exploited to purify the product. Purification may occur prior to calcination of the REE oxalates or after.

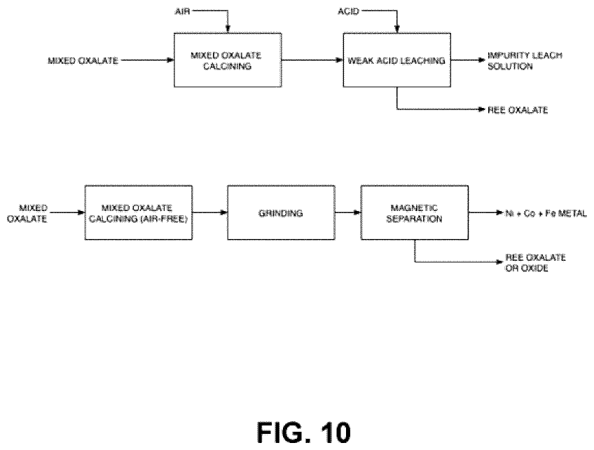

There are several variations of this embodiment. In one variation, a mixed oxalate precipitate comprising REEs and metal impurities is calcined between 150 and 1200° C. The resulting calcined product is then purified by leaching, washing, magnetic separation, or slag refining. The calcined product is leached in weak acid to remove the impurities, leaving behind REE oxalate. FIG. 10 depicts schematic block diagrams illustrating the above variations.

In embodiments, methods of the present disclosure may include performing non-selective calcination such that the temperature of the calcination is raised with a range from about 700° C. to about 1200° C.

In embodiments, a calcination process may be strategically selected based at least in part on the oxalate precipitation process, or vice versa. For example, when selective precipitation is performed, the oxalate precipitant may comprise highly pure REE oxalates. Therefore, the process does not have to rely on calcination to purify the product. As such, non-selective calcination may be performed following selective oxalate precipitation to convert the REE oxalates to REE oxides. In another example, when non-selective oxalate precipitation is performed, the oxalate precipitant may comprise greater amount of impurities than is desired (e.g., greater than 20%, 15%, 10%, 5%, 1%, 0.5% by mass). Therefore, the process may rely on selective calcination to purify the product. As such, selective calcination may be performed following non-selective oxalate precipitation to convert the impurities and REE oxalates to oxides for purification. The resulting REE oxide may comprise at least about 80%, or more typically at least about 85%, or more typically at least about 90%, or more typically at least about 95%, or more typically at least about 99%, or more typically at least about 99.5%, or more typically at least about 99.5% REE oxides by mass. That is, the resulting REE oxides may comprise less than about 20%, or more typically less than about 15%, or more typically less than about 10%, or more typically less than about 5%, or more typically less than about 1%, or more typically less than about 0.5%, or more typically less than about 0.1% by mass non-REE impurities such as aluminum, zinc, copper, boron, nickel, cobalt, etc.

Other REE recovery techniques may be employed than those expressly disclosed herein, such as solvent extraction.

### Impurity Removal:

Trace level of impurities can have an adverse impact on the usability and value of high purity products. Removal of aluminum, copper, zinc, and other impurities from the product solution may be accomplished using precipitation with calcium oxide, calcium hydroxide, magnesium oxide, magnesium hydroxide, sodium hydroxide, or other alkaline reagents, or a combination thereof. Solvent extraction and ion exchange may also be used to remove trace impurities.

Precipitation, solvent extraction, and/or ion exchange may remove at least most (i.e., about 75%, 80%, 85%, 90%, 95%, 99%, 99.5% by mass) of the remaining impurities from the process solution such that the process solution is substantially free (i.e., comprises less about 25%, less than about 20%, less than about 15%, less than about 10%, less than about 5%, less than about 1%, less than about 0.5% by mass) of iron, aluminum, copper, and zinc.

Cobalt and/or Nickel Removal:

Magnets may comprise cobalt and/or nickel which are valuable critical metals and can be separated from the process solution using solvent extraction and/or precipitation as a hydroxide using a reagent such as, but not limited to, lime or sodium hydroxide, magnesium oxide, calcium oxide, magnesium hydroxide, and calcium hydroxide producing a mixed cobalt-nickel hydroxide product. Nickel and cobalt may be removed separately or simultaneously from the process solution based on the removal method. Nickel and/or cobalt removal may take place after rare earth element precipitation and secondary iron removal occurs. In embodiments, nickel and/or cobalt removal may occur at a pH ranging from about pH 5.5 to about pH 10.

The precipitating reagent may be added to the process solution in amount ranging from about 50% to about 200% based on the stoichiometric amount of the nickel and/or cobalt in solution.

In embodiments, nickel and/or cobalt removal may occur at a temperature ranging from about 25° C. to about 90° C., with a reaction time ranging from about 30 minutes to about 6 hours.

The nickel and cobalt precipitation may recover at least most (i.e., at least about 75%, at least about 80%, at least about 85%, at least about 90%, at least about 95%, at least about 99%, at least about 99.5% by mass) of the nickel and/or cobalt from the process solution. That is, less than about 25%, or about 20%, or about 15%, or about 10%, or about 5%, or about 1%, or about 0.5% by mass of nickel and/or cobalt may remain in the process solution following nickel and cobalt precipitation.

As a result of the precipitation, a mixed hydroxide precipitate (MHP) may form comprising nickel and/or cobalt. The MHP may have comprise less than about 25%, or more typically less than about 20%, or more typically less than about 15%, or more typically less than about 10%, or more typically less than about 5%, or more typically less than about 1%, or more typically less than about 0.5% by mass impurities (e.g., non-nickel or cobalt elements/compounds).

### Boron Removal:

Boron may be recovered from the process solution using ion exchange or solvent extraction to produce products such as, but not limited to, zinc borate, boric acid, and/or sodium borate.

In embodiments, boron removal may occur before or after nickel and/or cobalt removal and may be based on the pH of the ion exchange resin, pH of the process solution, amount of boron in solution, amount of nickel and/or cobalt in solution, selected precipitating agents, etc., or a combination thereof.

In a non-limiting example of ion exchange to remove boron, a boron-containing aqueous process solution with a pH of about pH 6 to about pH 11 is treated with a boron-selective ion exchange resin, and boron is adsorbed onto the resin. The boron-selective ion exchange resin may be selected from a group of commercially available resins including but not limited to Amberlite PWA10, Ambersep IRA743, Purolite S108, Bestion BD501 and Mitsubishi Diaion CRB05. The boron can be eluted from the boron-loaded resin with one or more of hydrochloric acid, nitric acid, sulphuric acid, formic acid, citric acid, or a combination thereof.

The boron removal may recover at least most (i.e., at least about 75%, at least about 80%, at least about 85%, at least about 90%, at least about 95%, at least about 99%, at least about 99.5% by mass) of the boron from the process solution. That is, less than about 25%, or about 20%, or about 15%, or about 10%, or about 5%, or about 1%, or about 0.5% of boron by mass may remain in the process solution following the boron removal process.

As a result of the boron removal, a boron product may comprise less than about 25%, or more typically less than about 20%, or more typically less than about 15%, or more typically less than about 10%, or more typically less than about 5%, or more typically less than about 1%, or more typically less than about 0.5% by mass impurities (e.g., non-boron elements/compounds).

### Overall Chemical Process:

An overall chemical process may combine a series of the above chemical processing steps to convert a variety of magnet-comprising feeds into a rare earth concentrate as well as optional secondary concentrates of iron, nickel, cobalt, boron or other elements.

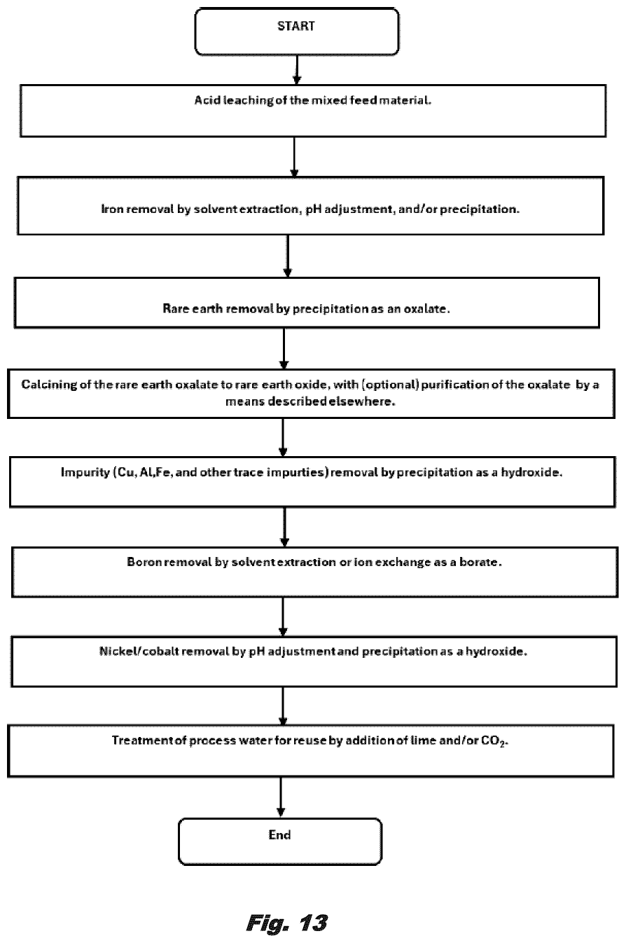

An exemplary process 1300 is summarized in FIG. 13.

Optionally, a first step (not depicted) may include washing of the feed using water, surfactant, solvent, or a combination thereof, as described in more detail above. Washing may be performed based on whether the mixed feed comprises oil or residue. Additionally or alternatively, process 1300 may include roasting of the (washed) feed at a temperature of 600° C. to 1000° C., as described in more detail above. based on the feed material. Roasting may be performed to improve leaching recovery based on the composition of the feed material.

Step 1301 involves acid leaching of the mixed feed material as noted above, with one or more of hydrochloric acid, nitric acid, sulphuric acid, formic acid, citric acid or a combination thereof.

Step 1302 involves iron removal by pH adjustment and precipitation as discussed above.

Step 1303 involves rare earth recovery by precipitation as an oxalate as discussed above wither reference to oxalate precipitation.

Step 1304 involves calcining of the rare earth-comprising oxalate to rare earth oxide by a means described above.

Step 1305 involves impurity removal (i.e., removal of copper, aluminum, iron, and other trace impurities) from the process solution by precipitation as a hydroxide, as described in more detail above.

Step 1306 includes boron recovery from the process solution by solvent extraction or ion exchange, as described in more detail above.

Step 1307 involves nickel/cobalt recovery from the process solution by pH adjustment and precipitation as a hydroxide, as described in more detail above.

Step 1308 involves treatment of process water for reuse, such as by addition of lime and/or carbon dioxide. The process 1300 then terminates.

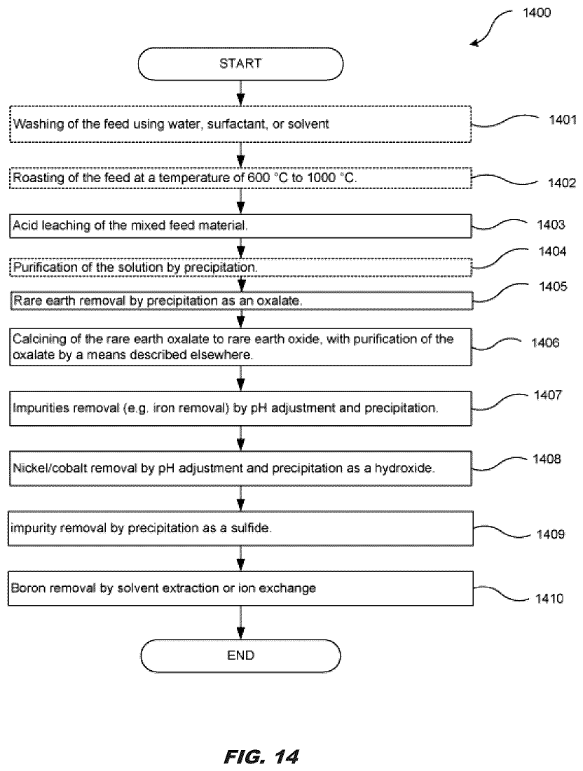

A variation of process 1300 is shown as process 1400 depicted in FIG. 14 containing additional steps not present in FIG. 13.

Step 1401 involves washing of the feed (e.g., swarf and/or magnet concentrate) using water, surfactant, solvent, or a combination thereof, as described in more detail above.

Step 1402 involves roasting of the washed feed at a temperature of 600° C. to 1000° C., as described in more detail above.

Step 1403 involves acid leaching of the mixed feed material with one or more of hydrochloric acid, nitric acid, sulphuric acid, formic acid, citric acid or a combination thereof to form a pregnant leach solution, as described in more detail above.

Step 1404 involves purification of the pregnant leach solution by precipitation. Step 1404 may include removing a first amount of iron from the pregnant leach solution. If in step 1404, the iron is precipitated out of solution too aggressively (e.g., to remove substantially all or most of the iron), then REEs will also start precipitating out, resulting in REE losses. Therefore, there is a balance between removing most of the iron while and minimizing REE losses.

Step 1405 involves rare earth removal by precipitation as an oxalate, as described in more detail above.

Step 1406 involves calcining of the rare earth oxalate to rare earth oxide, with purification of the oxalate by a means described above.

Step 1407 involves impurities removal (e.g., iron removal) from the process solution by pH adjustment and precipitation. Step 1407 may target removal of the remaining iron in the solution to produce high purity biproducts, such as a nickel and/or cobalt product and a boron product.

Step 1408 involves nickel and/or cobalt removal by pH adjustment and precipitation as a hydroxide, as described in more detail above.

Step 1409 involves impurity removal by precipitation. Impurity removal may target trace amounts of copper and zinc. In some embodiments, the precipitation includes addition of sulfuric acid to form a sulfide precipitate. In some embodiments, the precipitation includes addition of sulfide such as sodium sulfide and hydrogen sulfide. Step 1409 is optional and may or may not be used based on the composition of the solution, the desired purity levels, etc.

Step 1410 involves boron removal by solvent extraction or ion exchange, as described in more detail above.

In embodiments, any water produced by the process disclosed herein may be subjected to further purification steps to remove contaminants from the water so the water can be re-used or disposed of.

Optionally, process water may then be treated for reuse, such as by addition of lime and/or carbon dioxide.

The process 1400 then terminates.

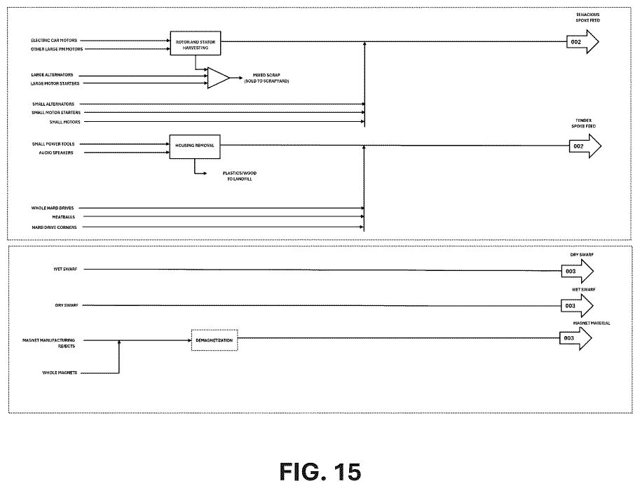

Other exemplary processes, according to embodiments of the present disclosure, are depicted in FIGS. 15 to 17.

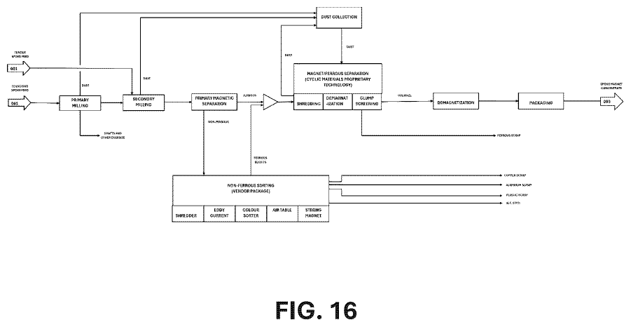

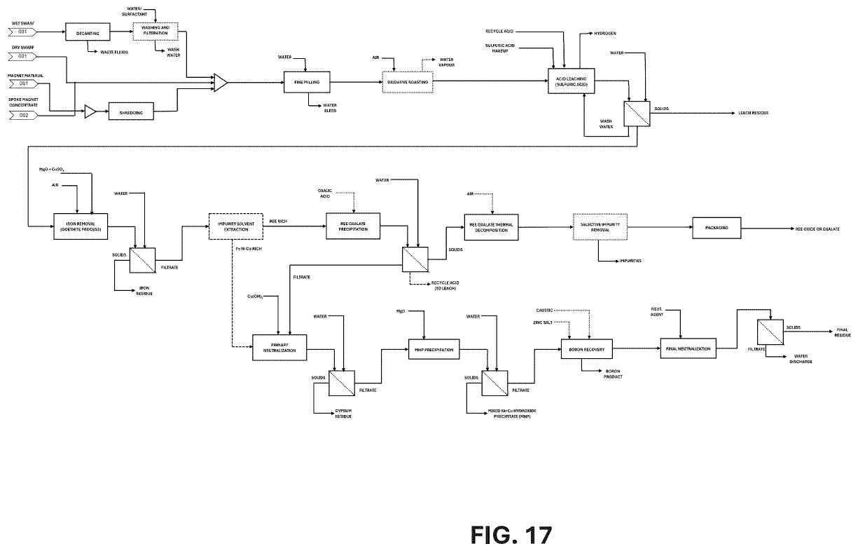

With reference to FIG. 15, various end of life devices and other magnetic-containing waste are depicted including: rotors and stators harvested from electric car motors and other large permanent magnet (“PM”) motors, large alternators and large motor starters, small alternators, small motor starters, and small motors, all of which are forwarded to primary milling (FIG. 16); small power tools and audio speakers (from which the housing is removed before recycle), whole hard drives, meatballs, and hard drive corners, all of which are forwarded to secondary milling (FIG. 16); wet swarf, which is forwarded to decanting, washing and dewatering (FIG. 17); dry swarf, which is combined with the decanted, washed and filtered (and dewatered) wet swarf and the combined swarf is forwarded to fine milling (FIG. 17); and magnet manufacturing rejects and whole magnets (e.g., from MRI machines and wind turbines), which is optionally demagnetized and forwarded to shredding (FIG. 17).

Referring to FIG. 16, the tender spoke feed and tenacious spoke feed (which refers to the description of different magnet containing materials as shown in FIG. 15) is subjected to primary milling and/or secondary milling as shown to form a milled material, which is subjected to primary magnetic separation (discussed above), with the nonferrous byproduct being passed through a non-ferrous sorting operation (comprising a shredder and the metal separation unit operations of eddy current separation, color sorting, air table sorting, and strong magnet sorting to provide copper scrap, aluminum scrap, plastic scrap, and nonferrous steel and a ferrous reject material). The ferrous reject material is combined with the ferrous material from primary magnetic separation and passed through a magnet/ferrous separation operation (comprising shredding, demagnetization (discussed above), and clump screening) to produce ferrous scrap and oversize material, which is demagnetized and packaged as a spoke magnetic concentrate to be forwarded to a hub or chemical processing facility.

Referring to FIG. 17, which depicts the hub or chemical processing facility, magnet manufacturing rejects and whole magnets (e.g., from MRI machines and wind turbines), which is optionally demagnetized and forwarded to shredding and is combined with the spoke magnet concentrate (from FIG. 16), the decanted, washed and filtered wet swarf and dry swarf and subjected to fine (wet) milling, optionally oxidative roasting (as described herein), and the residue subjected to acid leaching with a sulfuric acid lixiviant (as described herein). The leach residue is discarded, and the pregnant leach solution is subjected to iron removal using a Goethite or other iron removal process to remove most of the iron (as described herein) and filtered to form an iron residue and filtrate containing most of the rare earths, nickel, and cobalt with a small amount of residual iron. The filtrate is subjected to optionally impurity solvent extraction or other similar process such as ion exchange (described herein) to form a rare earth rich solvent phase containing most of the rare earths and a base metal rich solvent phase containing most of the nickel and cobalt with most of the residual iron. The rare earth rich solvent phase or filtrate after iron removal is subjected to rare earth oxalate precipitation using oxalic acid (as described herein), the resulting slurry filtered, and the retentate containing the rare earth precipitates subjected to rare earth oxalate thermal decomposition (as described herein), optional selective impurity removal (as described herein) to remove impurities and form a substantially pure rare earth oxalate or pure rare earth oxide. The base metal rich solvent from the impurity solvent extraction operation or filtrate from rare earth oxalate precipitation is optionally subjected to primary pH neutralization using a suitable base, such as calcium hydroxide, and the neutralized solution filtered to form a filtrate containing most of the base metal and a retentate containing most of the gypsum. The filtrate is optionally passed to (“MHP”) precipitation using magnesium oxide (described herein) to precipitate the nickel and cobalt as hydroxides. The solution is optionally filtered to remove a retentate comprising mixed nickel and cobalt hydroxide precipitates (constituting most of the nickel and cobalt in the solution) and the filtrate containing most of the boron is optionally subjected to born recovery using a caustic and zinc salt (described herein) or ion exchange to form a boron product. The solution is subjected to final neutralization and filtration to form a final waste residue and clean water for recycle or discharge.

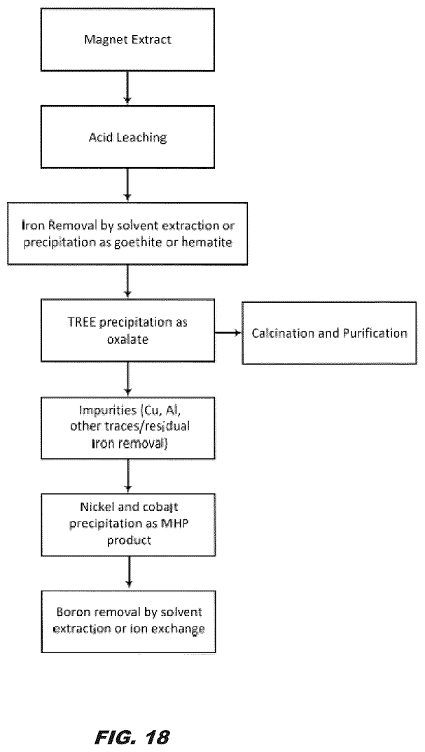

Another exemplary chemical process, according to embodiments of the present disclosure is depicted in FIG. 18. FIG. 18 depicts a process in which a magnet extract (such as mixed swarf, magnet manufacturing rejects, whole magnet and spoke magnet concentrate of FIG. 17) is subjected to acid leaching (such as the sulfuric acid leaching operation of FIG. 17). The pregnant leach solution is subjected to solvent extraction or other similar process as noted above in FIG. 17 to remove iron or alternatively by adjusting the solution pH with calcium oxide, calcium hydroxide, calcium carbonate, magnesium oxide, magnesium hydroxide, magnesium carbonate, sodium hydroxide, or other alkaline reagents or minerals, or a combination thereof in an oxidative environment (i.e., in the presence of oxygen) achieved by the use of air, oxygen gas, or hydrogen peroxide, mixture of sulfur dioxide with oxygen or air gasses, permanganate, or other known oxidants in the industry or a combination thereof to precipitate iron, such as in the form of goethite or hematite, and other impurities. The iron barren pregnant leach solution after iron removal is subjected to rare earth precipitation using oxalic acid to precipitate most of the rare earths as oxalates as shown in FIG. 17, which precipitates are subjected to calcination and purification as described herein. The rare earth barren solution, containing most of the remaining base metals, is subjected to impurity removal to remove copper, aluminum, and other trace/residual iron as shown in FIG. 17, and the remaining nickel and cobalt in the resulting treated solution is precipitated as an MHP product as shown in FIG. 17 followed by boron removal by solvent extraction or ion exchange as shown in FIG. 17.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

The methods and systems of the present disclosure are further described by way of the following illustrative, non-limiting experimental Examples 1 through 7.

### Example 1. Leaching

Acid leaching comprises leaching of rare earth bearing magnet material with one or more of hydrochloric acid, nitric acid, sulphuric acid, formic acid, citric acid, or a combination thereof. The magnet material concentrate can be subjected to a leaching procedure characterized by the following: a pulp density of about 1% to about 30% by mass, an acid concentration of about 50 g/L to about 1600 g/L, a reaction time of about 0.5 hour to about 8 hours, a temperature up to about 100° C. and reaction pH of about 0 to 2.5.

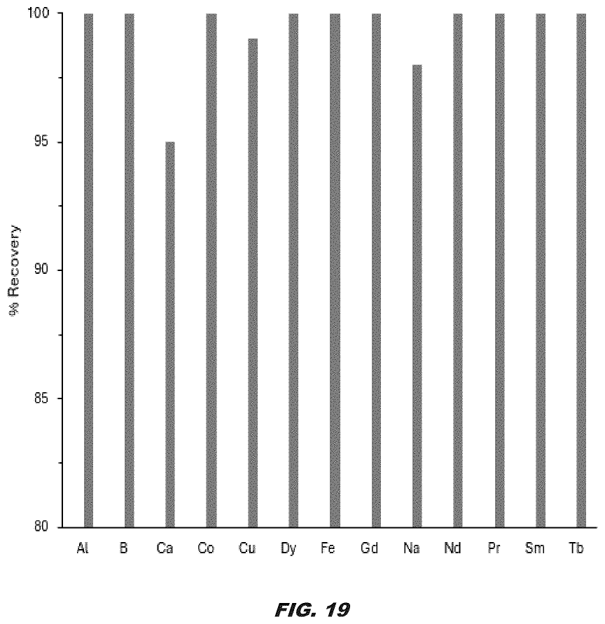

In a particular example, a magnet extract (composition of which is provided by Table 2) generated from processing of different types of mixed feed in a particular campaign was leached using about 10% pulp density, about 800 g/L sulphuric acid, about a 5 hour reaction time, about 80° C. temperature, and a constant reaction pH of 1. FIG. 19 shows the percentage recovery of different metals and confirmed the quantitative recovery of REEs under proposed experimental conditions.

### Leaching Reactions

2Al₍ₛ₎+3H₂SO_{4(aq)}=Al₂(SO₄)_{3(aq)}+3H_{2(g)}

2B₍ₛ₎+3H₂SO_{4(aq)}=2H₃BO_{3(aq)}+3SO_{2(g)}

Ca₍ₛ₎+H₂SO_{4(aq)}=CaSO_{4(aq)}+H_{2(g)}

Co₍ₛ₎+H₂SO_{4(aq)}=CoSO_{4(aq)}+H_{2(g)}

Cu₍ₛ₎+H₂SO_{4(aq)}=CuSO_{4(aq)}+H_{2(g)}

2Dy₍ₛ₎+3H₂SO_{4(aq)}=Dy₂(SO₄)_{3(aq)}+3H_{2(g)}

Fe₍ₛ₎+H₂SO_{4(aq)}=FeSO_{4(aq)}+H_{2(g)}

2Gd₍ₛ₎+3H₂SO_{4(aq)}=Gd₂(SO₄)_{3(aq)}+3H_{2(g)}

Mg₍ₛ₎+H₂SO_{4(aq)}=MgSO_{4(aq)}+H_{2(g)}

2Nd₍ₛ₎+3H₂SO_{4(aq)}=Nd₂(SO₄)_{3(aq)}+3H_{2(g)}

Ni₍ₛ₎+H₂SO_{4(aq)}=NiSO_{4(aq)}+H_{2(g)}

2Pr₍ₛ₎+3H₂SO_{4(aq)}=Pr₂(SO₄)_{3(aq)}+3H_{2(g)}

2Sm₍ₛ₎+3H₂SO_{4(aq)}=Sm₂(SO₄)_{3(aq)}+3H_{2(g)}

2Tb₍ₛ₎+3H₂SO_{4(aq)}=Tb₂(SO₄)_{3(aq)}+3H_{2(g)}

TABLE 2
Composition of a mixed metal magnet extract.

| Al | B | Ca | Co | Cu | Dy | Fe | Gd | Na | Nd | Pr | Sm | Tb |
|---|---|---|---|---|---|---|---|---|---|---|---|---|
| % | % | % | % | % | % | % | % | % | % | % | % | % |
| 0.26 | 0.97 | 0.22 | 1.08 | 0.19 | 0.98 | 66.48 | 0.05 | 0.02 | 27 | 0.3 | 0.96 | 0.33 |

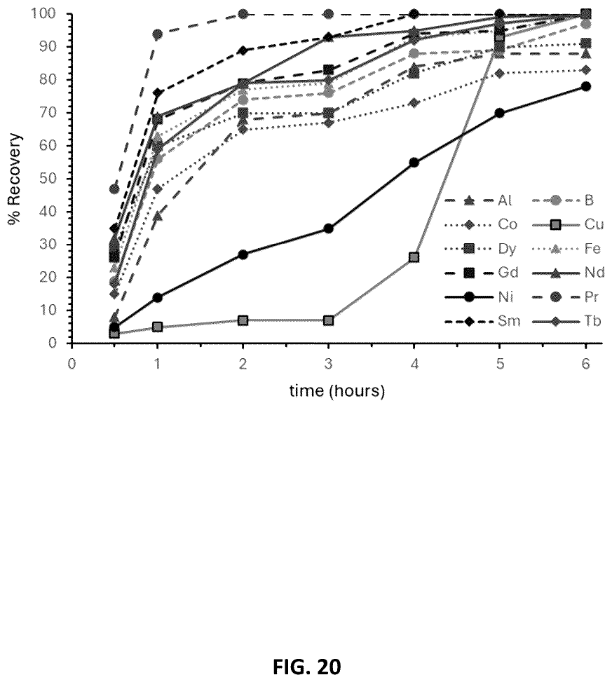

The magnet extract produced from another campaign (composition of which is provided by Table 3) was subjected to study leaching kinetics under similar experimental conditions as mentioned above. The variation of time from 0.5 hours to 6 hours showed quantitative recovery of REEs. FIG. 20 demonstrates the percent recovery of the various metals over time, where REEs including gadolinium, samarium, neodymium, praseodymium, and terbium reached near 100% recovery levels.

TABLE 3
Composition of a mixed metal magnet extract.

| Al | B | Co | Cu | Dy | Eu | Fe | Gd | Nd | Ni | Pr | Sm | Tb |
|---|---|---|---|---|---|---|---|---|---|---|---|---|
| % | % | % | % | % | % | % | % | % | % | % | % | % |
| 1.23 | 1.04 | 0.45 | 0.24 | 0.18 | <0.01 | 61.99 | 0.39 | 18.5 | 0.02 | 5.14 | 0.58 | 0.03 |

### Example 2. Iron Removal

Iron can be removed by solvent extraction and precipitation as goethite or hematite. Iron removal comprises using calcium oxide, calcium hydroxide, calcium carbonate, magnesium oxide, magnesium hydroxide, magnesium carbonate, sodium hydroxide, or other alkaline reagents or minerals, or a combination thereof in an oxidative environment achieved using air, oxygen gas, or hydrogen peroxide, mixture of sulfur dioxide with oxygen or air gasses, permanganate, or other known oxidants in the industry or a combination thereof. The addition of copper ions and the use of solvent extraction may also be applied. To date, test work has achieved removal of up to about 99% iron in solution.

In an example, iron removal as goethite can be performed under the following experimental conditions: iron concentration from about 1 g/L to about 100 g/L, a pH equal to about pH 2.0 to about pH 6.0, about 50 wt. % hydrogen peroxide solution of about 2% to about 30 wt. % in the reaction, magnesium oxide slurry in the range of about 5% to about 70 wt. %, about 0.1% to 5% by weight of copper sulphate solution of about 25 g/L to about 100 g/L, temperature of about 30° C. to about 95° C. and reaction time of about 1 hour to about 10 hours.

In another particular example, a pregnant leach solution comprising about 58 g/L iron and about 27.2 g/L total rare earth elements (TREE) was subjected to goethite removal with the following conditions: a pH of about pH 2.5, about 20% hydrogen peroxide (50 wt. %), about 30% Mg(OH)₂ for pH adjustment, about 0.5% of 84.2 g/L copper sulphate solution, about 80° C. temperature, and about a 5 hours reaction time. As a result, greater than about 99.5% iron was removed with less than about 7% loss of TREE.

### Example 3. Oxalate Precipitation

The pregnant leach solution (PLS) after the removal of impurities of one or more of iron, aluminum, copper, and zinc may be subjected to TREE oxalate precipitation. The precipitation is carried out at a pH of about pH 0.5 to about pH 5.5, a temperature up to about 90° C., oxalic acid dosage ranging from about 50 to about 200% stochiometric addition relative to the TREE, and a reaction time in between about 5 minutes and about 2 hours.

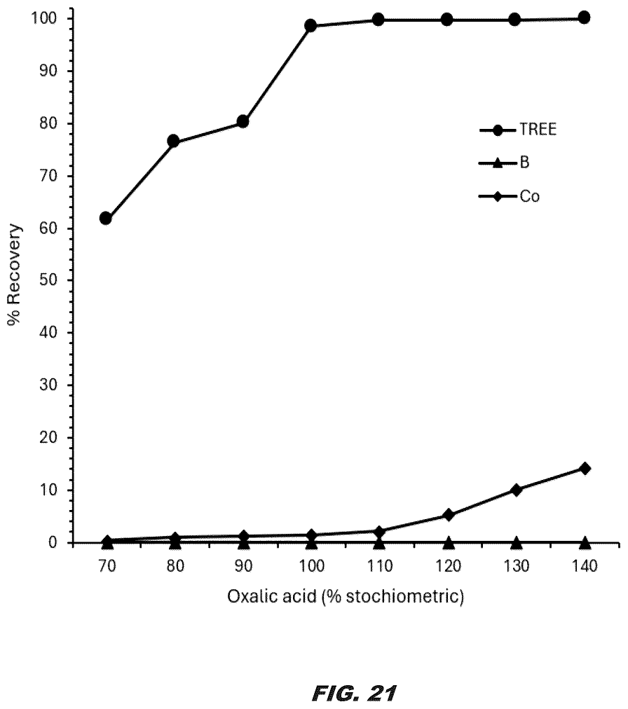

In this specific example, the filtrate after impurities removal was tested for TREE precipitation. In this series of tests, precipitation conditions included: a pH equal to about pH 1.0, an oxalate dosage from about 70% to about 140% stochiometric, about a 500 rpm stirring speed, at room temperature, and a reaction time of about 30 minutes. TREE recovery increased from about 61.7% to about 99.9% by increasing the oxalate dosage from about 70% to about 140% stoichiometric. Results of this example are demonstrated in FIG. 21, in which TREE were selectively recovered relative to boron and cobalt.

### Example 4. Calcination

The oxalate precipitate may be subjected to selective calcination for impurity removal such as but not limited to nickel, cobalt, and iron oxalates by calcination at low temperatures or calcination at high temperature to recover rMREO. The calcination can be carried out in one or two steps at a temperature of about 150° C. to about 1200° C., in presence of air, and reaction time ranging from about 30 minutes to about 8 hours.

In this specific example, calcination was performed with the following conditions: about 0.5 kg oxalate precipitate was calcined at about 1000° C. with an air flow of about 5 L/min for 4 hours. Greater than about 97.75% pure rMREO was recovered.

### Example 5. Cobalt and Nickel Recovery

Magnets may comprise cobalt and nickel which are valuable critical metals and can be separated from the process solution using solvent extraction and/or precipitation as a hydroxide using a reagent such as, but not limited to, lime or sodium hydroxide, magnesium oxide, calcium oxide, magnesium hydroxide, and calcium hydroxide producing a mixed cobalt-nickel hydroxide product.

The filtrate after rare earths precipitation and secondary iron removal, as disclosed herein, was subjected to cobalt and nickel precipitation. A mixed hydroxide precipitate (MHP) comprising cobalt and nickel can be generated under the following conditions: a pH ranging from about pH 5.5 to about pH 10, a magnesium oxide dosage ranging from about 50 to about 200% stochiometric addition, a temperature of about 25° C. to about 90° C., and a reaction time of about 30 minutes to about 6 hours.

In this particular example, about 1 kg solution mass comprising about 6.2 g of cobalt and about 0.005 g of nickel) was subjected to MHP precipitation at a pH of about pH 6.6 to about pH 8.6, a 100% molar ratio MgO dosage, a temperature of about 60° C. for about 4 hours resulting in the recovery of 73 g MHP product comprising about 7.5 wt. % cobalt and about 0.01 wt. % nickel.

### Example 6. Boron Removal

Boron is removed from the process solution using ion exchange or solvent extraction to produce products such as, but not limited to, zinc borate, boric acid, and/or sodium borate.

In one embodiment, boron can be removed before or after MHP precipitation using ion exchange or solvent extraction. A boron-containing aqueous solution with a pH of about pH 6 to about pH 11 is treated with a boron-selective ion exchange resin, and boron is adsorbed onto the resin. The boron-selective ion exchange resins include commercially available resins including but not limited to Amberlite PWA10, Ambersep IRA743, Purolite S108, Bestion BD501 and Mitsubishi Diaion CRB05. The resulting resin can be eluted with one or more but not limited to hydrochloric acid, nitric acid, sulphuric acid, formic acid, citric acid, or a combination thereof.

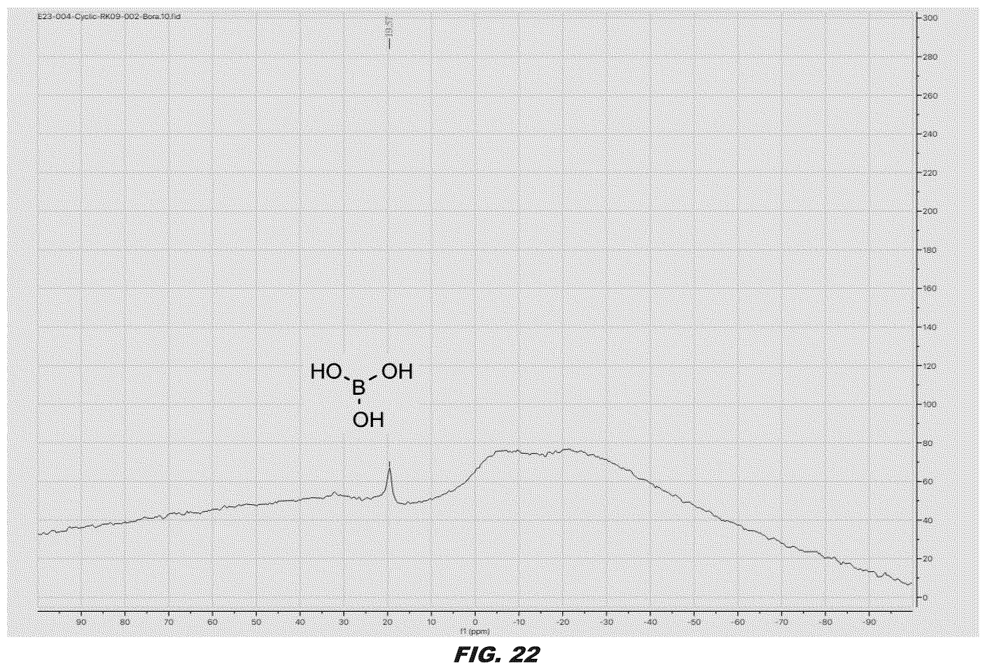

In an example, a process solution bearing about 630 mg/L boron at pH of about pH 6.8 was passed at a flow rate of about 1 BV/h (2.5 mL/min) through a column (2.5×30 cm) with an H/D of about 12 containing Bestion BD501 resin and a bed volume (BV) of about 150 mL. A boron capacity of about 2.7 g/L was identified for Bestion BD501. The loaded boron was eluted with about 10 wt. % sulphuric acid and the resin could be regenerated using NaOH or NH₄OH solution. The recovery of boron as boric acid was demonstrated from elute via crystallization. The resulting solid was analyzed using ¹¹B NMR in D₂O as depicted in FIG. 22.

As used herein, “at least one”, “one or more”, and “and/or” are open-ended expressions that are both conjunctive and disjunctive in operation. For example, each of the expressions “at least one of A, B, and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B, and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

A number of variations and modifications of the disclosure can be used. It would be possible to provide for some features of the disclosure without providing others.

The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of preparing a magnet concentrate, comprising:
step (a) receiving a mixed feed comprising ferrous material and magnets having different chemical compositions, wherein at least a portion of the magnets comprise rare earth elements;
step (b) passing the mixed feed material through at least one size reduction apparatus to form size reduced material comprising a set of magnet-comprising clumps and non-clumped material;
step (c) separating the set of magnet-comprising clumps from the non-clumped material; and
step (d) passing the set of magnet-comprising clumps through a size reduction device to separate the ferrous material from target magnet material.

2. The method of claim 1, wherein the at least one size reduction apparatus comprises one or more hammer mills and wherein a first portion of the magnets comprise neodymium magnets and a second portion of the magnets comprise samarium cobalt magnets.

3. The method of claim 1, wherein step (b) comprises:
passing the mixed feed material through a hammer mill, wherein the hammer mill outputs a size reduced material;
passing at least a portion of the size reduced material through another hammer mill to form further size reduced material;
passing the further size reduced material over a remagnetization apparatus to re-magnetize magnets and to form the set of magnet-comprising clumps and non-clumped material using a screening device.

4. The method of claim 1, wherein the set of magnet-comprising clumps is substantially composed of the magnets and the ferrous material and wherein the non-clumped material is substantially composed of non-magnetic and ferrous material.

5. The method of claim 1, wherein the at least one size reduction device comprises a mill containing media such as balls, or rods and wherein a portion of the magnets comprise one of or more of samarium cobalt, neodymium, Alnico, and ferrite.

6. The method of claim 1, wherein at least most of the magnets comprise rare earth magnets.

7. The method of claim 1, wherein a portion of the magnets are free of rare earth elements.

8. The method of claim 1, wherein the magnets comprise neodymium magnets, samarium cobalt magnets, cobalt-containing magnets other than samarium cobalt magnets, nickel-comprising magnets, and mixtures thereof.

9. The method of claim 1, wherein the mixed feed comprises a mixture of recycled materials comprising rare earth element-comprising magnets, the recycled materials comprising one or more of motors, hard disk drives, speakers, compressors, meatballs, electromagnetic imaging devices, and other electromechanical devices containing magnets, and wherein the magnets are contained within the recycled materials.

10. The method of claim 1, wherein the target magnetic material comprises less than about 75 wt. % ferrous and non-magnetic material.

11. The method of claim 1, wherein the target magnetic material comprises at least about 25% rare earth element-comprising magnets.

12. The method of claim 1, wherein at least about 50 wt. % of the rare earth magnets of the mixed feed are captured in the target magnetic material.

13. The method of claim 1, further comprising:
demagnetizing the set of magnet-comprising clumps, after step (c) and prior to step (d), to break up the set of magnet-comprising clumps prior to entering the size reduction device.

14. The method of claim 1, further comprising:
passing magnet manufacturing waste, swarf material, and/or quality reject magnet material comprising rare earth element-comprising magnets through a comminuting apparatus to form comminuted material, wherein one or more of the comminuting apparatus, the at least one size reduction apparatus, and/or the size reduction device are the same or different; and
combining the comminuted material with the target magnet material.

15. The method of claim 14, wherein the swarf material comprises oil, the method further comprising:
washing, prior to the comminuting apparatus, the swarf material with water, a surfactant, a solvent, or a combination thereof to remove at least most of the oil from the swarf.

16. The method of claim 1, wherein the magnets in the size reduced feed material has a degree of magnetization that is less than a degree of magnetization of the magnets in the feed material and wherein step (c) comprises:
separating, by a ferromagnetic surface, the size reduced feed material into a magnetic portion and a non-magnetic portion, the ferromagnetic surface comprising one of a ferromagnetic iron drum, ferromagnetic conveyor belt idler, and ferromagnetic collection band; and
passing the size reduced material over a set of N screens to produce N+1 product fractions, the fractions comprising the magnet-comprising clumps and the non-clumped material.

17. The method of claim 1, further comprising:
removing, prior to step (a), substantially all of copper, aluminum and any other non-ferromagnetic material from the mixed feed, wherein the mixed feed of step (a) comprises less than about 10 wt. % copper, aluminum and any other non-ferromagnetic material.

18. The method of claim 1, wherein a first portion of the magnets comprise one of samarium cobalt, neodymium, praseodymium, terbium, dysprosium, or a combination thereof and a second portion of the magnets comprise one of Alnico and ferrite and further comprising:
acid leaching the target magnet material to form a pregnant leach solution comprising iron, one or more of neodymium, samarium, praseodymium, terbium, and dysprosium, and one or more of cobalt and nickel;
precipitating at least a portion of the iron from the pregnant leach solution to form an iron-depleted solution comprising the one or more of neodymium, samarium, praseodymium, terbium, and dysprosium, and the one or more of cobalt and nickel and an iron-containing precipitate;
removing at least a portion of the one or more of neodymium, samarium, praseodymium, terbium, and dysprosium, from the iron-depleted solution to form a rare earth product comprising one or more of neodymium, samarium, praseodymium, terbium, and dysprosium; and
removing at least a portion of the one or more of cobalt and nickel from the iron-depleted solution to form a metal product comprising one or more of cobalt and nickel.

19. The method of claim 18, wherein the target magnet material further comprises boron, the method further comprising:
removing at least a portion of boron from the iron-depleted solution to form a boron metal product.

20. The method of claim 18, wherein the target magnet material further comprises impurities, the method further comprising:
removing at least most of the impurities from the iron-depleted solution, wherein the impurities comprise copper, aluminum, and trace iron.

21. A method comprising:
step (a) acid leaching magnet comprising material to form a pregnant leach solution comprising iron, one or more of neodymium, samarium, praseodymium, terbium, and dysprosium, and one or more of cobalt and nickel;
step (b) removing at least a portion of the iron from the pregnant leach solution to form an iron-depleted solution comprising the one or more of neodymium, samarium, praseodymium, terbium, and dysprosium, and the one or more of cobalt and nickel and an iron-containing material;
step (c) removing at least a portion of the one or more of neodymium, samarium, praseodymium, terbium, and dysprosium from the iron-depleted solution to form a rare earth product comprising one or more of neodymium, samarium, praseodymium, terbium, and dysprosium; and
step (d) removing at least a portion of the one or more of cobalt and nickel from the iron-depleted solution to form a metal product comprising one or more of cobalt and nickel.

22. The method of claim 21, wherein removing at least the portion of the one or more of neodymium, samarium, praseodymium, terbium, and dysprosium from the iron-depleted solution comprises:
precipitating the one or more of neodymium, samarium, praseodymium, terbium, and dysprosium from the iron-depleted solution to form a rare earth precipitate; and
calcining the rare earth precipitate to form a rare earth oxide.

23. The method of claim 22, wherein the one or more of neodymium, samarium, praseodymium, terbium, and dysprosium are precipitated as an oxalate or a carbonate or a salt.

24. The method of claim 21, wherein the magnet comprising material further comprises boron, the method further comprising:
removing, after step (c) and before or after step (d), at least a portion of boron from the iron-depleted solution to form a boron metal product.

25. The method of claim 21, wherein the magnet comprising material further comprises impurities, the method further comprising:
removing, after step (c) and before step (d), at least most of the impurities from the iron-depleted solution, wherein the impurities comprise copper, aluminum, and trace iron.

26. The method of claim 21, wherein the magnet comprising material comprises at least about 25% rare earth element comprising magnets, and wherein the rare earth element-comprising magnets comprises neodymium magnets, samarium cobalt magnets, or both.

27. The method of claim 21, wherein the magnet material comprises less than about 50 wt. % ferrous and non-magnetic material.

28. The method of claim 21, wherein the magnet material is derived from a mixed feed comprising magnets, and wherein the mixed feed comprises neodymium magnets, samarium cobalt magnets, cobalt-containing magnets other than samarium cobalt magnets, nickel-comprising magnets, and mixtures thereof.

29. The method of claim 28, further comprising:
washing oil-comprising swarf material with water, a surfactant, a solvent, or a combination thereof to remove at least most of the oil from the swarf material;
passing the swarf material or scrap magnet comprising rare earth element-comprising magnets through a size reduction apparatus to form size reduced swarf.

30. The method of claim 29, further comprising:
combining the size reduced swarf with magnet-comprising material derived from a mixed feed to form the magnet comprising material.

31. The method of claim 29, wherein step (b) comprises:
precipitating at least a portion of the iron from the pregnant leach solution to form an iron-depleted solution and an iron-containing precipitate.

32. The method of claim 29, wherein step (b) comprises:
extracting, via solvent extraction, at least a portion of the iron from the pregnant leach solution to form an iron-depleted solution and an iron-containing goethite or hematite.

33. A method, comprising:
step (a) receiving a mixed feed comprising ferrous material and magnets having different chemical compositions, wherein at least a portion of the magnets comprise rare earth elements;
step (b) passing the mixed feed material through a size reduction apparatus, wherein the size reduction apparatus outputs a size reduced material;
step (c) passing at least a portion of the size reduced material from step (b) through one or more comminuting apparatuses to form a comminuted material, the comminuted material comprising a set of magnet-comprising clumps and non-clumped material;
step (d) separating the set of magnet-comprising clumps from the non-clumped material; and
step (e) passing the set of magnet-comprising clumps through a size reduction device to separate the ferrous material from target magnet material.

34. The method of claim 33, wherein the size reduced material from step (b) comprises a first set of magnet-comprising clumps and a first non-clumped material, the method further comprising:
separating the first set of magnet-comprising clumps from the first non-clumped material, wherein the first set of magnet-comprising clumps are passed through the one or more comminuting apparatuses in step (c) and/or the size reduction device in step (e).

35. The method of claim 34, wherein separating the first set of magnet-comprising clumps from the first non-clumped material comprises:
passing the size reduced material from step (b) over a set of N screens to produce N+1 product fractions, the fractions comprising the first magnet-comprising clumps and the first non-clumped material.

36. The method of claim 33, wherein the size reduced material from step (b) comprises a first set of magnet-comprising clumps and a first non-clumped material, wherein both the first set of magnet-comprising clumps and the first non-clumped material are passed through the one or more comminuting apparatuses in step (c) and/or the size reduction device in step (e).

37. The method of claim 33, wherein step (d) comprises:
passing the comminuted material from step (c) over a remagnetiziation apparatus to remagnetize magnets of the comminuted material and to separate the set of magnet-comprising clumps and non-clumped material.

38. The method of claim 33, wherein the target magnetic material comprises rare earth element-comprising magnets comprising one or more of neodymium, samarium, praseodymium, terbium, and dysprosium.

39. The method of claim 33, wherein the target magnetic material comprises less than about 75 wt. % ferrous material.

40. The method of claim 33, wherein the size reduction apparatus, the one or more comminuting apparatuses, and the sizer reduction device are the same or different.
